(19) United States
(12) Patent Application Publication
(10) Pub. No.: US 2018/0167976 A1
(43) Pub. Date: Jun. 14, 2018

(54) WIRELESS MEDIUM ACCESS OPERATIONS

(71) Applicant: QUALCOMM Incorporated, San Diego, CA (US)

(72) Inventor: Maarten Menzo Wentink, Nijmegen (NL)

(21) Appl. No.: 15/831,109

(22) Filed: Dec. 4, 2017

Related U.S. Application Data
(60) Provisional application No. 62/433,147, filed on Dec. 12, 2016.
(60) Provisional application No. 62/437,947, filed on Dec. 22, 2016.
(60) Provisional application No. 62/444,688, filed on Jan. 10, 2017.

(51) Int. Cl. H04W 74/08

(52) U.S. Cl. CPC H04W 74/0816; H04W 84/12

(57) ABSTRACT

Systems and methods are disclosed for a wireless device to share a wireless medium with other devices. The wireless device may perform a first backoff using a first backoff value, transmit on the wireless medium after performing the first backoff, and use a non-random backoff value to perform a subsequent backoff when the transmission is successful.

### CROSS-REFERENCE TO RELATED APPLICATIONS

This Patent Application claims priority to U.S. Provisional Patent Application No. 62/433,147 entitled “EQUAL MEDIUM ACCESS FOR MULTIPLE WIRELESS DEVICES” filed on Dec. 12, 2016, to U.S. Provisional Patent Application No. 62/437,947 entitled “EQUAL MEDIUM ACCESS FOR MULTIPLE WIRELESS DEVICES” filed on Dec. 22, 2016, and to U.S. Provisional Patent Application No. 62/444,688 entitled “EQUAL MEDIUM ACCESS FOR MULTIPLE WIRELESS DEVICES” filed on Jan. 10, 2017, all assigned to the assignee hereof. The disclosures of all prior Applications are considered part of and are incorporated by reference in this Patent Application.

### TECHNICAL FIELD

The example embodiments relate generally to wireless networks, and specifically to medium access operations between wireless devices.

### BACKGROUND OF RELATED ART

A Wi-Fi network may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the Wi-Fi network. The beacon frames, which may include a traffic indication map (TIM) indicating whether the AP has queued downlink data for the STAs, are typically broadcast according to a target beacon transmission time (TBTT) schedule.

In a typical Wi-Fi network, only one device may use a shared wireless medium at any given time. To arbitrate access to the shared wireless medium, the IEEE 802.11 standards define a distributed coordination function (DCF) that instructs individual STAs (and APs) to “listen” to the medium to determine when the medium is idle (e.g., using a “carrier sense” technique). When a STA detects that the wireless medium has been continuously idle for a DCF Interframe Space (DIFS) duration, the STA may attempt to transmit data on the wireless medium. Many Wi-Fi networks operating in the 5 GHz frequency band employ an Enhanced Distributed Channel Access (EDCA) mechanism for medium access contention operations. The EDCA mechanism is an example of a listen-before-talk (LBT) protocol.

For example, to prevent multiple devices from accessing the wireless medium at the same time, each device may select a random “backoff” value, number or period. At the end of the DIFS duration, a contention period begins during which each device waits for a period of time determined by its backoff value or number (e.g., its backoff period) before it attempts to transmit data on the wireless medium. The device that selects the lowest backoff value will have the shortest backoff period (e.g., the earliest slot time in the contention period or window), and therefore “wins” the medium access contention operation. If multiple devices select the same backoff value and then attempt to transmit data at the same time, a collision occurs and the devices contend for medium access again using an exponential backoff procedure in which each device doubles the value of its backoff value for each subsequent medium access contention operation.

An exponential backoff procedure and a random backoff value determined by each wireless device may cause the medium access delay to increase significantly. Therefore, it may be advantageous to provide ways for multiple wireless devices to have fair access to the wireless medium in a moderate backoff scheme.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

In some aspects, a wireless device is disclosed and is configured to share access to a wireless medium with other devices. The first wireless device may include one or more processors. The first wireless device may also include a memory configured to store instructions that, when executed by the one or more processors, cause the wireless device to perform a first backoff using a first backoff value, transmit on the wireless medium after performing the first backoff, and use a non-random backoff value to perform a subsequent backoff when the transmission is successful.

In further aspects, a method for a wireless device to share access to a wireless medium with other wireless devices includes performing a first backoff using a first backoff value, transmitting on the wireless medium after performing the first backoff, and using a non-random backoff value to perform a subsequent backoff when the transmission is successful.

In other aspects, a non-transitory computer-readable storage medium is disclosed. The non-transitory computer-readable storage medium may store one or more programs containing instructions that, when executed by one or more processors of a wireless device, cause the wireless device to share access to a wireless medium with other devices. The number of operations may include performing a first backoff using a first backoff value, transmitting on the wireless medium after performing the first backoff, and using a non-random backoff value to perform a subsequent backoff when the transmission is successful.

In further aspects, a wireless device is disclosed and is configured to share access to a wireless medium with other devices. The first wireless device may include means for performing a first backoff using a first backoff value, means for transmitting on the wireless medium after performing the first backoff, and means for using a non-random backoff value to perform a subsequent backoff when the transmission is successful.

### BRIEF DESCRIPTION OF THE DRAWINGS

Aspects of the present disclosure are illustrated by way of example and are not intended to be limited by the figures of the accompanying drawings. Like numbers reference like elements throughout the drawings and specification.

FIG. 1A shows an example wireless network.

FIG. 1B shows an example wireless network, such as illustrated in FIG. 1A, and a Load Based Equipment (LBE) wireless network.

FIG. 2 shows an example EDCA device.

FIG. 3 shows an example LBE device.

FIG. 4 depicts an example relationship between calibrated contention window sizes for LBE devices and an average number of interruptions per transmission.

FIGS. 5A-5F depict example medium access success rates for LBE devices that adjust their contention window sizes based on the graph of FIG. 4 and example medium access success rates for EDCA devices.

FIG. 6A depicts an example relationship between calibrated contention window sizes for LBE devices and contention window offset values as a function of the average number of interruptions per transmission.

FIG. 6B depicts an example operation for converging a contention window size to a target value for LBE devices.

FIG. 7 depicts an example relationship between calibrated contention window sizes for LBE devices and an average collision rate.

FIG. 8 depicts example medium access success rates for LBE devices that adjust their contention window sizes based on the graph of FIG. 7 and example medium access success rates for EDCA devices.

FIG. 9 shows an illustrative flowchart depicting an example operation for selecting contention window sizes for LBE devices.

FIG. 10 depicts an example relationship between calibrated contention window sizes for EDCA devices and an average number of interruptions per transmission.

FIGS. 11A-11G depict example medium access success rates for EDCA devices that adjust their contention window sizes based on the graph of FIG. 10.

FIG. 12 shows an illustrative flowchart depicting an example operation for selecting contention window sizes for EDCA devices.

FIG. 13A shows an illustrative flowchart depicting an example operation for dynamically adjusting a selected contention window size.

FIG. 13B shows another illustrative flowchart depicting an example operation for dynamically adjusting a selected contention window size.

FIG. 14 shows an example graph illustrating the simulated access delay for a first initialized wireless device using exponential backoff in a described example.

FIG. 15 shows a graph illustrating the change in contention window size for the first initialized wireless device during the same simulation as for FIG. 14.

FIG. 16 shows an illustrative flowchart depicting an example operation for a wireless device to determine a non-random backoff value when all wireless devices use the same contention window size, in accordance with some aspects of the present disclosure.

FIG. 17 shows a graph illustrating the simulated change in contention window size for the first initialized wireless device from the example for FIG. 14 when the wireless devices perform the example operation of FIG. 16.

FIG. 18 shows a graph illustrating the simulated access delay for the first initialized wireless device during the same simulation as for FIG. 17.

FIG. 19 shows an illustrative flowchart depicting an example operation for a wireless device to determine a new slot of the contention window when detecting collisions, in accordance with some aspects of the present disclosure.

FIG. 20 shows an illustrative flowchart depicting an example operation for an idle wireless device to determine when to initiate transmissions, in accordance with some aspects.

FIG. 21 shows a graph illustrating the simulated contention window size for a wireless device in an illustrative example operation.

FIG. 22 shows a graph illustrating the simulated contention window size for a wireless device initialized after the wireless device from the example for FIG. 21.

FIG. 23 shows a graph illustrating the simulated wireless medium access delay (in ms) for the first wireless device and the next initialized device from the example for FIG. 21 and FIG. 22.

FIG. 24 shows a graph illustrating the simulated contention window size for a wireless device in an alternate illustrative example operation to the example for FIGS. 21-23.

FIG. 25 shows a graph illustrating the simulated contention window size for a wireless device initialized after the wireless device from the example for FIG. 24.

FIG. 26 shows a graph illustrating the simulated wireless medium access delay (in ms) for the wireless device and the next initialized device from the example for FIG. 24 and FIG. 25.

FIG. 27 shows an illustrative flowchart depicting an example operation for a wireless device beginning to listen to a wireless medium to determine the length of the non-random backoff, in accordance with some aspects of the present disclosure.

FIG. 28 shows an illustrative flowchart depicting an example operation for a receiving device to infer a collision for a received wireless signal, in accordance with some aspects of the present disclosure.

### DETAILED DESCRIPTION

Aspects of the present disclosure are described below in the context of a wireless system including a wireless local area network (WLAN) and an LBE wireless network for simplicity only. It is to be understood that the example embodiments are equally applicable to other wireless networks (e.g., cellular networks, pico networks, femto networks, satellite networks). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs. The terms “backoff number” and “backoff value” may also be used interchangeably.

In the following description, numerous specific details are set forth such as examples of specific components, circuits, and processes to provide a thorough understanding of the present disclosure. The term “coupled” as used herein means connected directly to or connected through one or more intervening components or circuits. The term “medium access” as used herein may refer to gaining and/or controlling access to a shared wireless medium. The term “transmit opportunity” (TXOP) as used herein may refer to a period of time during which a device (or a portion of the device) may transmit data via the shared wireless medium. As used herein, the term “EDCA device” may refer to a wireless device that employs an exponential backoff procedure for collision avoidance, for example, in accordance with the EDCA mechanisms defined in the IEEE 802.11e standards.

Wireless protocols other than EDCA may also be deployed in the 5 GHz band, which should share channel access fairly with Wi-Fi. For example, channel access mechanisms may be introduced as defined in European Telecommunications Standards Institute (ETSI) Broadband Access Network (BRAN) for Load Based Equipment (LBT for LBE) (see ETSI EN 301 893 V1.7.1, clause 4.9.2.2).

Further, as used herein, the term “LBE device” may refer to a wireless device that does not employ an exponential backoff procedure for collision avoidance, for example, such as wireless devices operating in accordance with the LBE standards provided by the ETSI. It is noted that channel access mechanisms associated with the ETSI's Broadband Access Network (BRAN) for LBE may also be referred to as LBT for LBE, and thus the terms “LBE device” and “LBT for LBE device” may be used interchangeably herein.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scopes all embodiments defined by the appended claims.

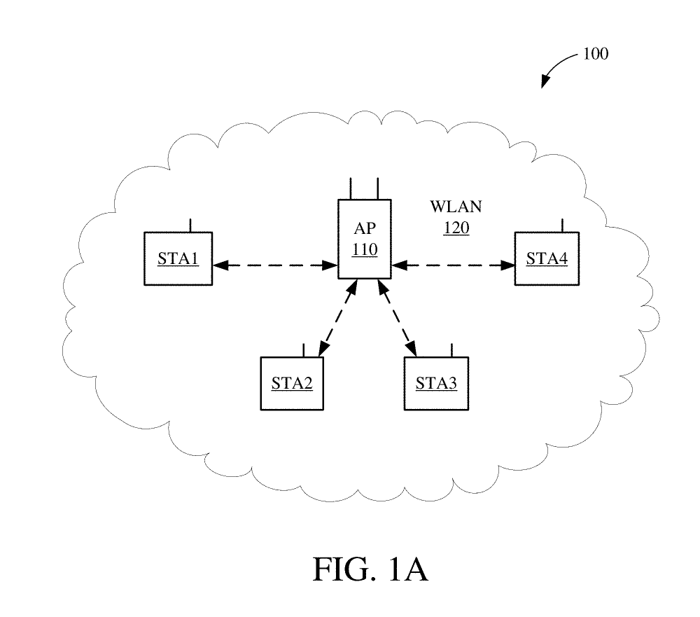

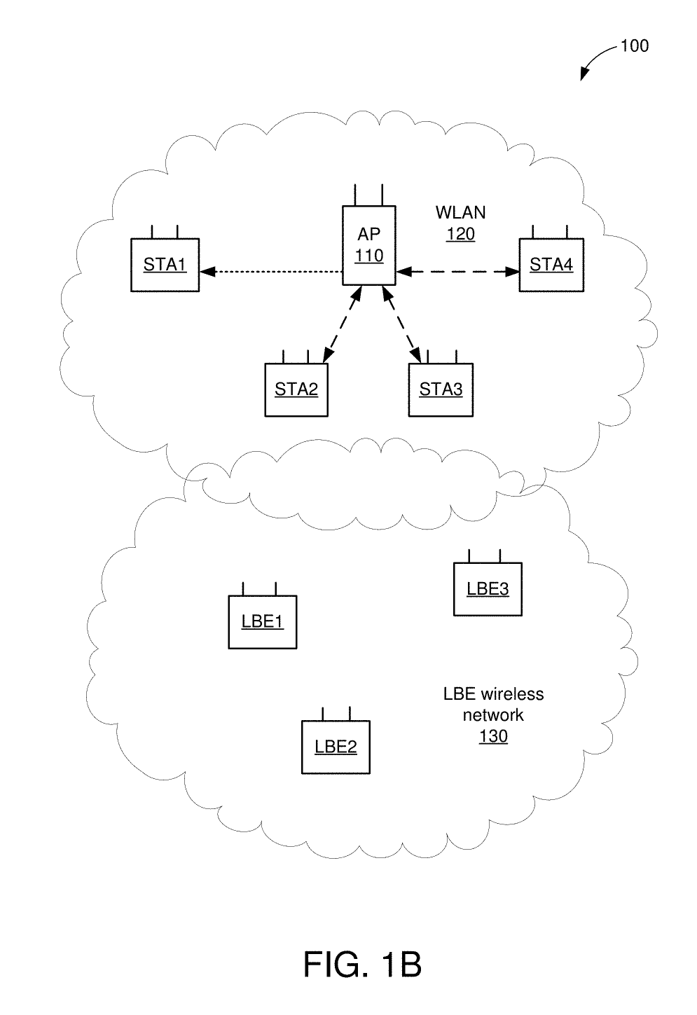

FIG. 1A is a block diagram of a wireless system 100 within which aspects of the present disclosure may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1A (and FIG. 1B) for simplicity, it is to be understood that WLAN 120 may be formed by any number of access points such as AP 110. The AP 110 is assigned a unique MAC address that is programmed therein by, for example, the manufacturer of the access point. Similarly, each of stations STA1-STA4 is also assigned a unique MAC address. For some embodiments, the wireless system 100 may correspond to a multiple-input multiple-output (MIMO) wireless network. Further, although the WLAN 120 is depicted in FIG. 1A (and FIG. 1B) as an infrastructure BSS, for other aspects, WLAN 120 may be an IBSS, an ad-hoc network, or a peer-to-peer (P2P) network (e.g., operating according to the Wi-Fi Direct protocols).

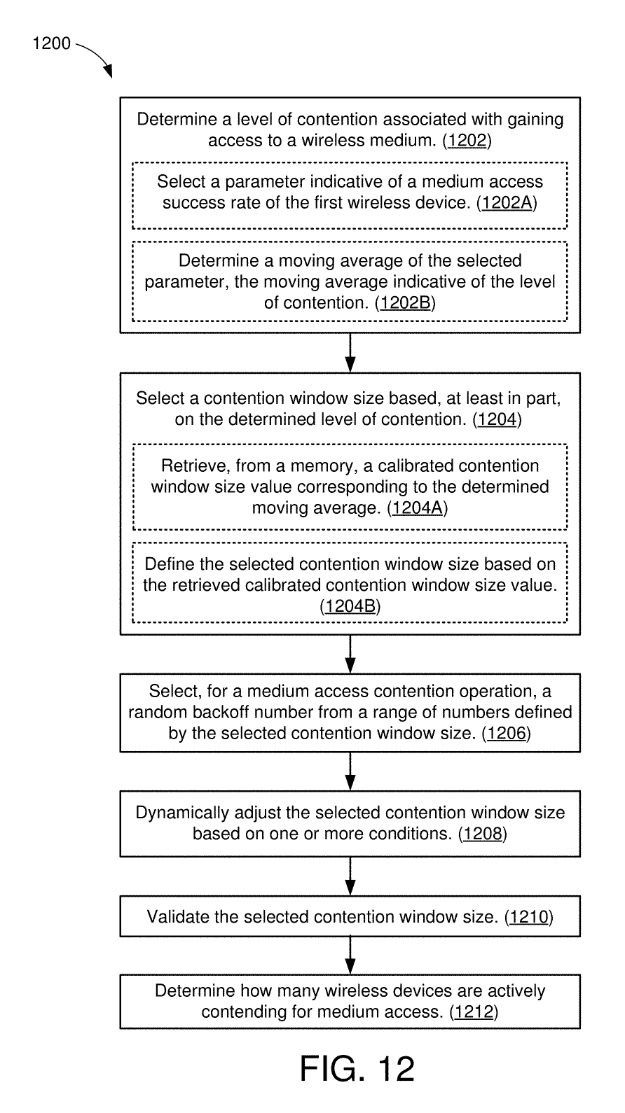

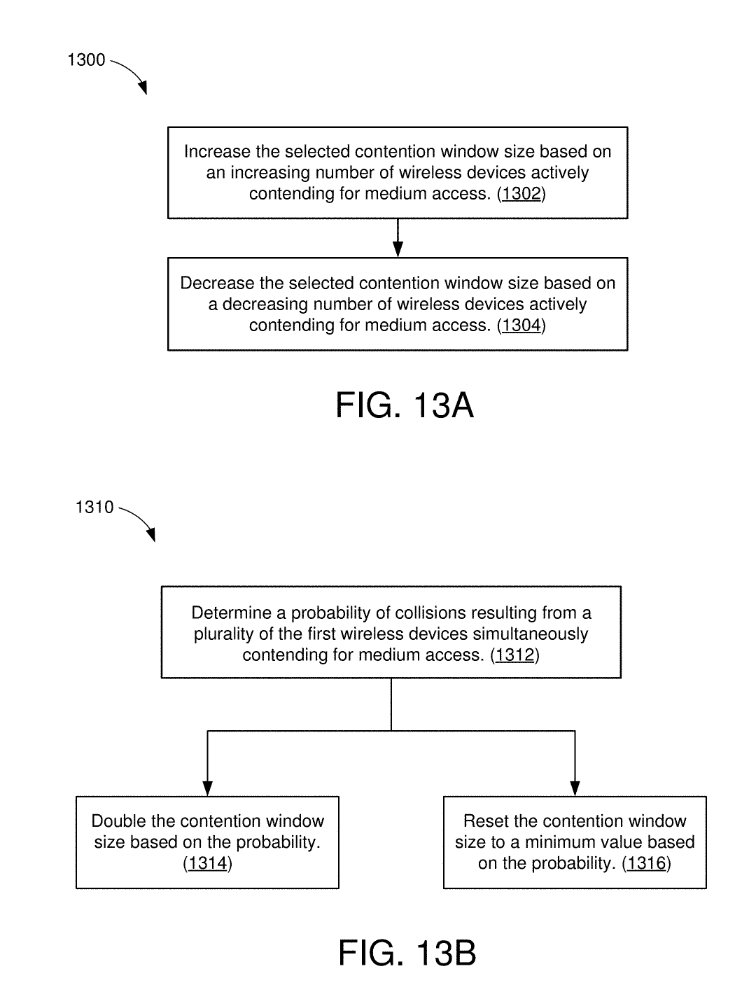

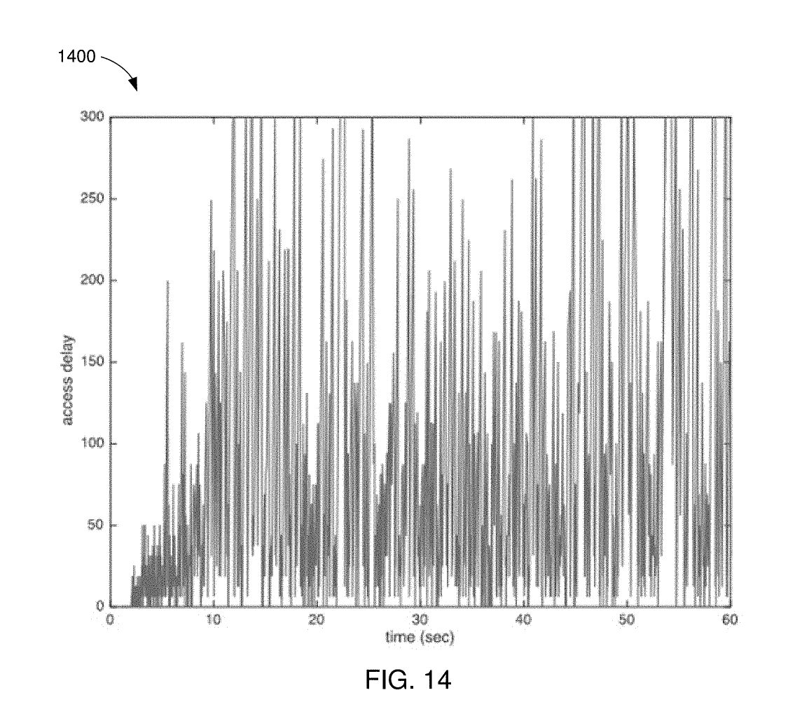

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 12 and 13A-13B.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that may store instructions for performing operations described below.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

As mentioned above, to prevent multiple devices from accessing a shared wireless medium at the same time, the IEEE 802.11 standards define a distributed coordination function (DCF) that instructs individual devices to determine that the shared wireless medium has been idle for a time period before attempting to transmit data. Specifically, after the shared wireless medium has been idle for a DIFS duration, a contention period begins during which each device waits for a period of time determined by its randomly selected backoff number before it attempts to transmit data on the wireless medium. The device that selects the lowest backoff number has the shortest backoff period, and therefore “wins” access to the shared wireless medium. The winning device may be granted access to the shared wireless medium for a period of time commonly referred to as the transmit opportunity (TXOP).

Data may be selected for transmission over the shared medium according to priority levels, for example, so that higher priority data (e.g., voice data) may be allocated higher transmission priorities than lower priority data (e.g., emails). More specifically, data of different priority levels may be assigned different ranges of backoff numbers so that higher priority data is more likely to win a given medium access contention operation than lower priority data (e.g., by assigning lower backoff numbers to higher priority data and assigning higher backoff numbers to lower priority data). The different ranges of backoff numbers may be allocated to different priority levels of data by classifying data into access categories, and then providing a different range of backoff numbers to each access category (AC).

According to the enhanced distributed coordination channel access (EDCA) function described in the IEEE 802.11e standards, each STA is to include a different transmit queue for each access category (AC), and the transmit queues are to independently contend for medium access. Because an AP may serve multiple STAs at the same time, the AP may include a plurality of transmit queues for each AC. More specifically, the AP may classify downlink data (e.g., data to be transmitted to one or more of its associated STAs) based on a traffic identifier (TID) and a destination address (DA). The destination address (DA) indicates to which STA the data is to be transmitted. The TID indicates the priority level of the data, and may thus be mapped to a corresponding access category. By classifying downlink data according to its TID and DA, the AP may aggregate data of the same priority level in a common set of AC queues that select from a corresponding range of backoff numbers. The aggregated data may be transmitted over the wireless medium as aggregated data frames such as, for example, aggregate MAC protocol data units (AMPDUs) and/or aggregate MAC service data units (AMSDUs).

As mentioned above, each device contending for medium access may select (e.g., generate) a random backoff number that may correspond to one of the slot times of the contention period. More specifically, each device may initially set its contention window (CW) to a minimum value (CWₘᵢₙ), and then randomly selects its backoff number from a range of numbers between 0 and the CW value. After the wireless medium has been idle for a DIFS duration, each device may decrement its selected backoff number after each Arbitration Interframe Space (AIFS) duration. The AIFS duration may be based on the AIFS number (AIFSN), the slot time (ST), and a Short Interframe Space (SIFS) duration. The AIFSN may be based on the access category to which the transmit data is assigned. In general, the AIFS duration may be expressed as AIFS=AIFSN[AC]*ST+SIFS, where AIFSN[AC] is the AIFS number for the access category of the transmit data. For Wi-Fi networks operating in the 5 GHz frequency band (e.g., in accordance with the IEEE 802.11n/ac protocols), each slot time has a duration of 9 μs, the SIFS duration is 18 μs, and the DIFS duration is 34 μs.

If multiple devices select the same backoff number and attempt to transmit data at the same time, a collision occurs and the devices contend for medium access again using an exponential backoff procedure in which each device doubles the contention window for each subsequent medium access contention operation. When the contention window reaches a maximum value (CWₘₐₓ), the contention window size remains at CWₘₐₓ until one of the contending devices wins access to the shared wireless medium.

In contrast to the EDCA mechanisms defined in the IEEE 802.11e standards, LBE devices employ a contention window of a fixed size, commonly denoted as q, upon which to base selection of their backoff numbers. The value of q, which is an integer greater than or equal to one, may be based on the maximum duration of a transmission from an LBE device. For example, when the wireless medium has been idle for more than a time period, an LBE device may select a random backoff number between zero and the value of q, and may then decrement its backoff number after each slot time. The LBE device may transmit data on the wireless medium when its backoff number reaches zero if the LBE device does not sense a busy condition on the shared wireless medium. The slot time for LBE device is currently set at 20 μs.

Because EDCA devices double their contention window sizes after each occurrence of a collision and LBE devices maintain the same contention window size regardless of collisions, LBE devices may have an advantage in contending for medium access in the event of collisions, especially if the collisions result in multiple medium access contention operations. As the number of devices contending for medium increases (e.g., which increases the probability of collisions), LBE devices tend to have a higher-priority access to the shared wireless medium than EDCA devices.

Co-owned U.S. Utility patent application Ser. No. 14/994,604 (Publication No. US 2016/0212656), titled “Wi-Fi Compatible Channel Access,” filed Jan. 13, 2016, the entirety of which is hereby incorporated by reference, discloses apparatuses and methods to ensure fair access to a wireless medium shared between, e.g., LBE devices and EDCA devices. Some aspects of the previously filed application may be utilized in some aspects of the present disclosure. Therefore, the detailed description of the previously filed application is provided, in part, below.

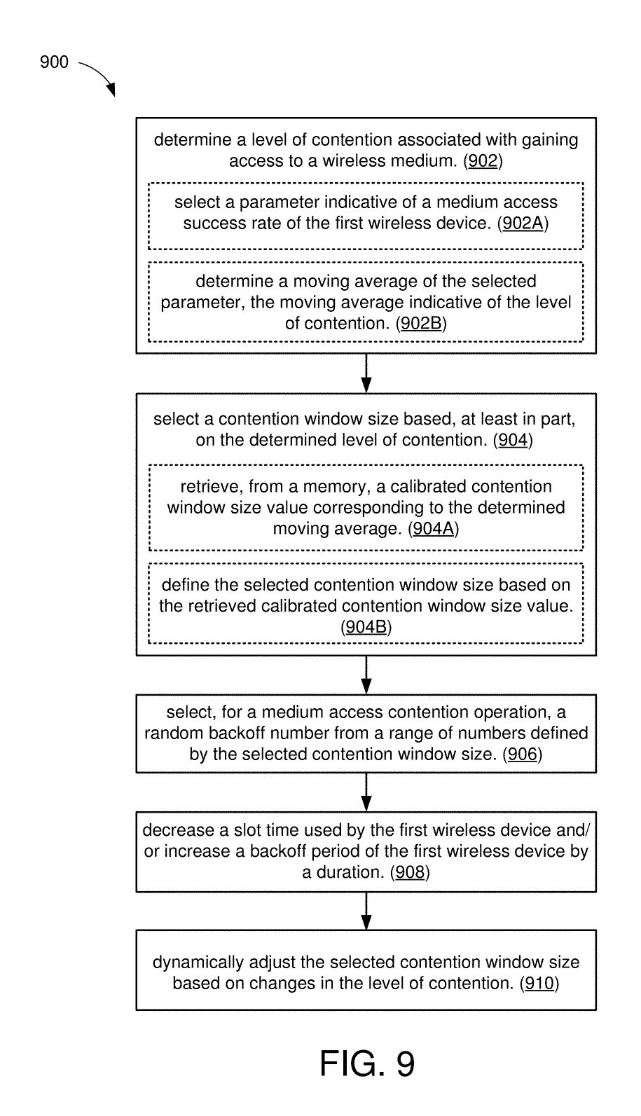

FIG. 1B is an example of wireless system 100, including the WLAN 120, and an LBE wireless network 130 within which aspects of the present disclosure may be implemented. The wireless system 100 may include, be adjacent to, or otherwise be associated with an LBE wireless network 130. The LBE wireless network 130 is depicted in FIG. 1B as including three LBE devices LBE1-LBE3. For other embodiments, the LBE wireless network 130 may include any suitable number of LBE devices and/or any suitable number of APs. Each of LBE devices LBE1-LBE3 may be any suitable wireless device including, for example, a cell phone, personal digital assistant (PDA), tablet device, laptop computer, or the like. Each station (STA) may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each LBE device may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 9.

For purposes of discussion herein, the WLAN 120 and the LBE wireless network 130 may operate on the same or similar frequency bands (e.g., the 5 GHz frequency band), and thus the stations STA1-STA4 of WLAN 120 and the LBE devices LBE1-LBE3 of the LBE wireless network 130 may contend with each other for access to a shared wireless medium, as described in more detail below.

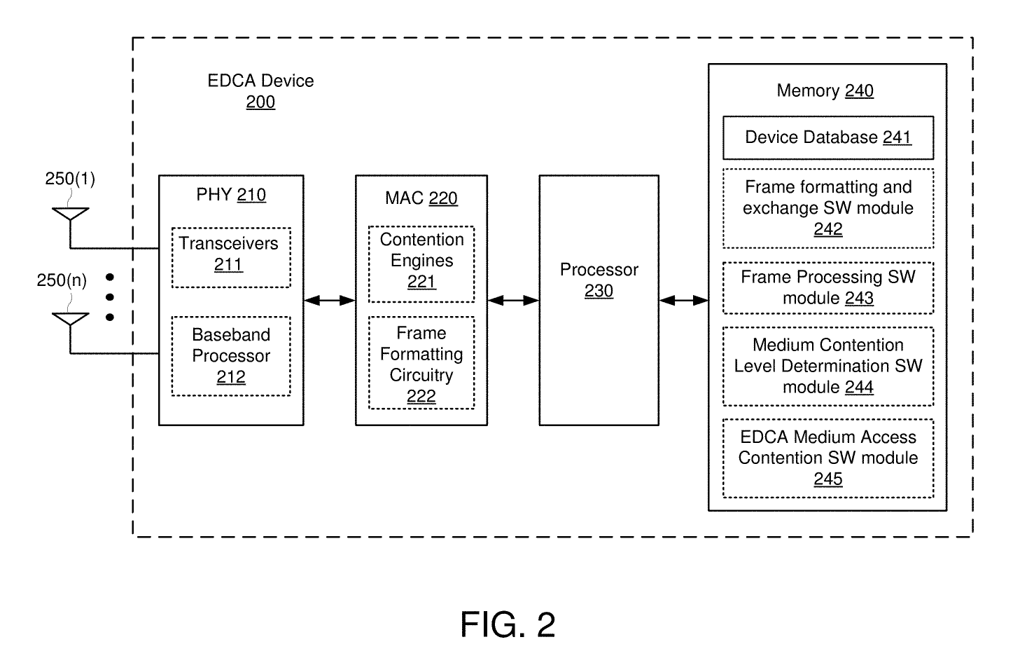

FIG. 2 shows an example EDCA device 200 that may be one embodiment of one or more of stations STA1-STA4 of FIG. 1B. The EDCA device 200 may include a PHY device 210 including at least a number of transceivers 211 and a baseband processor 212, may include a MAC 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1B), and may be used to scan the surrounding environment to detect and identify nearby access points and/or other STAs (e.g., within wireless range of EDCA device 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for some aspects, the EDCA device 200 may be configured for MIMO operations. The MIMO operations may include single-user MIMO (SU-MIMO) operations and multi-user MIMO (MU-MIMO) operations.

The baseband processor 212 may be used to process signals received from processor 230 and/or memory 240, and to forward the processed signals to transceivers 211 for transmission via one or more of antennas 250(1)-250(n). The baseband processor 212 may also be used to process signals received from one or more of antennas 250(1)-250(n) via transceivers 211, and to forward the processed signals to processor 230 and/or memory 240.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one more shared wireless mediums, and may also store packets for transmission over the one more shared wireless mediums. The EDCA device 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include a device database 241 that stores device profiles for a plurality of other wireless devices such as, for example, APs, other EDCA devices (or other STAs), and/or LBE devices. Each device profile may include information including, for example, the corresponding device's Service Set Identification (SSID), MAC address, channel information, RSSI values, goodput values, channel state information (CSI), supported data rates, connection history with the EDCA device 200, and any other suitable information pertaining to or describing the operation of the corresponding device.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 242 to facilitate the creation and exchange of any suitable frames (e.g., data frames, control frames, management frames, and/or action frames) between EDCA device 200 and other wireless devices (e.g., as described for one or more operations of FIGS. 12 and 13A-13B);
a frame processing SW module 243 to process received frames or packets (e.g., as described for one or more operations of FIGS. 12 and 13A-13B);
a medium contention level determination SW module 244 to determine a level of contention associated with gaining access to a wireless medium (e.g., as described for one or more operations of FIGS. 12 and 13A-13B); and
an EDCA medium access contention SW module 245 to select a contention window size, to select a random backoff number from a range of numbers defined by the selected contention window size, to count down the random backoff number, to dynamically adjust the selected contention window size, and/or to facilitate other operations associated with contending for medium access (e.g., as described for one or more operations of FIGS. 12 and 13A-13B).
   Each software module includes instructions that, when executed by processor 230, cause EDCA device 200 to perform the corresponding functions. The non-transitory computer-readable medium of memory 240 thus includes instructions for performing all or a portion of the operations depicted in FIGS. 12 and 13A-13B.

Processor 230 may be any suitable one or more processors capable of executing scripts or instructions of one or more software programs stored in EDCA device 200 (e.g., within memory 240). For example, processor 230 may execute the frame formatting and exchange software module 242 to facilitate the creation and exchange of any suitable frames (e.g., data frames, control frames, management frames, and/or action frames) between EDCA device 200 and other wireless devices. Processor 230 may execute the frame processing SW module 243 to process received frames or packets. Processor 230 may execute the medium contention level determination SW module 244 to determine a level of contention associated with gaining access to a wireless medium. Processor 230 may execute the EDCA medium access contention SW module 245 to select a contention window size, to select a random backoff number from a range of numbers defined by the selected contention window size, to count down the random backoff number, to dynamically adjust the selected contention window size, and/or to facilitate other operations associated with contending for medium access for EDCA device 200.

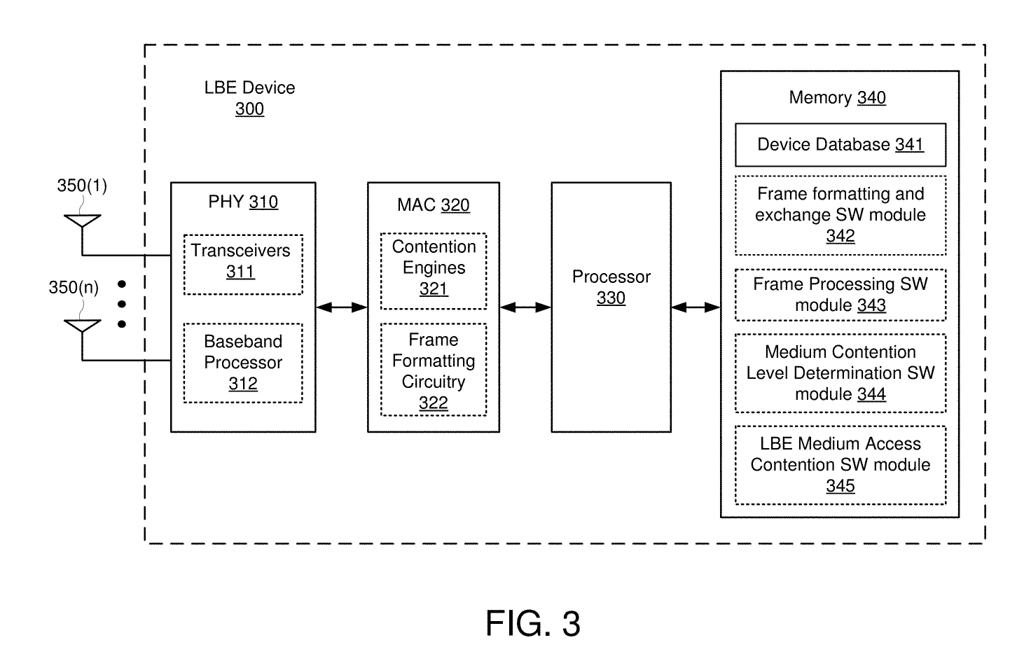

FIG. 3 shows an example LBE device 300 that may be one embodiment of one or more of LBE devices LBE1-LBE3 of FIG. 1B. The LBE device 300 may include a PHY device 310 including at least a number of transceivers 311 and a baseband processor 312, may include a MAC 320 including at least a number of contention engines 321 and frame formatting circuitry 322, may include a processor 330, may include a memory 340, and may include a number of antennas 350(1)-350(n). Operations of the PHY device 310, MAC 320, and antennas 350(1)-350(n) of LBE device 300 are similar to operations of PHY device 210, MAC 220, and antennas 250(1)-250(n) of EDCA device 200 described above with respect to FIG. 2, and are therefore not repeated herein for brevity.

Memory 340 may include a device database 341 that stores device profiles for a plurality of other wireless devices such as, for example, APs, other LBE devices, and/or EDCA devices. Each device profile may include information including, for example, the corresponding device's Service Set Identification (SSID), MAC address, channel information, RSSI values, goodput values, channel state information (CSI), supported data rates, connection history with the LBE device 300, and any other suitable information pertaining to or describing the operation of the corresponding device.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (e.g., data frames, control frames, management frames, and/or action frames) between LBE device 300 and other wireless devices (e.g., as described for one or more operations of FIG. 9);
a frame processing SW module 343 to process received frames or packets (e.g., as described for one or more operations of FIG. 9);
a medium contention level determination SW module 344 to determine a level of contention associated with gaining access to a wireless medium (e.g., as described for one or more operations of FIG. 9); and
an LBE medium access contention SW module 345 to select a contention window size, to select a random backoff number from a range of numbers defined by the selected contention window size, to count down the random backoff number, to dynamically adjust the selected contention window size, and/or to facilitate other operations associated with contending for medium access (e.g., as described for one or more operations of FIG. 9).
   Each software module includes instructions that, when executed by processor 330, cause the LBE device 300 to perform the corresponding functions. The non-transitory computer-readable medium of memory 340 thus includes instructions for performing all or a portion of the operations depicted in FIG. 9.

Processor 330 may be any suitable one or more processors capable of executing scripts or instructions of one or more software programs stored in LBE device 300 (e.g., within memory 340). For example, processor 330 may execute the frame formatting and exchange software module 342 to facilitate the creation and exchange of any suitable frames (e.g., data frames, control frames, management frames, and/or action frames) between LBE device 300 and other wireless devices. Processor 330 may execute the frame processing SW module 343 to process received frames or packets. Processor 330 may execute the medium contention level determination SW module 344 to determine a level of contention associated with gaining access to a wireless medium. Processor 330 may execute the LBE medium access contention SW module 345 to select a contention window size, to select a random backoff number from a range of numbers defined by the selected contention window size, to count down the random backoff number, to dynamically adjust the selected contention window size, and/or to facilitate other operations associated with contending for medium access for LBE device 300.

As discussed above, when contending for medium access, LBE devices may select a random backoff number between zero and the value of q (which as described above denotes the fixed contention window size conventionally associated with LBE devices). The value of q does not typically change, even if there are collisions resulting from medium access contention operations. Because EDCA devices use an exponential backoff procedure for collision avoidance, LBE devices may have an advantage over EDCA devices when contending for medium access, especially when collisions on the shared wireless medium result in additional contention operations between the LBE devices and the EDCA devices. Thus, as described in more detail below, the example embodiments may adjust medium access contention operations for LBE devices and/or EDCA devices in a manner that ensures that LBE devices and EDCA devices have similar success rates in accessing a shared wireless medium.

For some aspects, disparities in the likelihood of winning medium access between LBE devices and EDCA devices may be reduced by (1) decreasing the duration of the slot time used by LBE devices from 20 μs to 9 μs (or to other suitable time values) and (2) requiring LBE devices to add an AIFS duration to their random backoff numbers in the event of a collision. For example, decreasing the LBE slot time may allow LBE device 300 to begin an initial medium access contention operation sooner than conventional LBE devices, and requiring LBE device 300 to add an AIFS duration to its backoff number in the event of a collision may allow EDCA devices (such as EDCA device 200 of FIG. 2) to have a similar success rate in gaining medium access as the LBE device 300 during subsequent medium access contention operations. In this manner, the backoff periods for LBE device 300 may more closely resemble the backoff periods for EDCA devices such as EDCA device 200.

The size of the contention window (e.g., the value of q) from which LBE device 300 selects random backoff numbers may also be adjusted to ensure that LBE devices and EDCA devices have fair (e.g., equal) access to the shared wireless medium. For example, the LBE device 300 may determine a level of contention associated with gaining access to a wireless medium, may select a contention window size based, at least in part, on the determined level of contention, and may select a random backoff number from a range of numbers defined by the selected contention window size.

More specifically, the contention window size (q) may be adjusted based on observed collisions, transmission interruptions, and/or or inter-CCA (clear channel assessment) busy times in a manner that ensures that LBE devices and EDCA devices have equal chances of gaining medium access. In some aspects, LBE device 300 may maintain a moving average of one or more parameters indicative of a channel access success rate. The one or more “success rate” parameters may include, for example, (i) the average number of interruptions per transmission, (ii) the average collision rate, and (iii) the average time between medium busy events. For some implementations, the moving average (MA) may be determined as a simple (e.g., unweighted) moving average, for example, that may be expressed as:

$$M A = \frac{{SRP}_{0} + {SRP}_{1} + … + {SRP}_{n}}{n} \qquad ( EQ . 1 )$$

where SRP is a selected one of the success rate parameters, and n is an integer indicating the number of SRP values used to determine the moving average.

For other implementations, the moving average MA may be determined as a weighted moving average. For example, in some aspects, the moving average MA may be weighting using a damping factor (DF), and expressed as:

MA=(1−DF)*MA+DF*SRP (EQ. 2)

For at least some embodiments, the damping factor DF may be between approximately 0.5% and 10% (although for other embodiments, the damping factor DF may be of other suitable values).

In other aspects, a moderation factor (MF) may be used to adjust the value of q so as to converge to a target q value (q_{target}). For example, the q value may be expressed as:

q=q+MF*(q_{target}−q) (EQ. 3)

For at least some embodiments, the moderation factor MF may be between approximately 1% and 20% (although for other embodiments, the moderation factor MF may be of other suitable values).

It is noted that although increasing the damping factor value and/or the moderation factor value may increase the speed with which the value of q converges to the value of q_{target}, increasing the damping factor value and/or the moderation factor value may also increase signal fluctuations and jitter. Thus, the selection of the damping factor value and/or the moderation factor value may involve a trade-off between (1) the rate at which the value of q is adjusted in response to changing numbers of devices contending for medium access and (2) the rate at which the channel access success rate changes for each of the contending devices. For at least some implementations, the moving average value and the value of q may be updated after each transmission (e.g., after each contention period ends).

The LBE device 300 may select a suitable contention window size based on a relationship between values of q that result in the same (or similar) medium access success rates for LBE devices and EDCA devices and the moving average of a selected success rate parameter. More specifically, for some embodiments, the value of q may be calibrated (e.g., adjusted or otherwise modified from the fixed value defined by the ETSI standards) for each of a plurality of moving average values of the selected success rate parameter, for example, such that the LBE devices and EDCA devices have the same (or similar) medium access success rates. The resulting relationship between the calibrated q values and the moving averages of the selected success rate parameter may be plotted as a graph (which may be referred to herein as a “calibrated q graph”). In some aspects, the calibrated q graph may be stored in the LBE device (e.g., within memory 340 of LBE device 300). Thereafter, when contending for medium access, the LBE device 300 may measure, obtain, or otherwise determine the selected success rate parameter, and then select a corresponding calibrated q value from the calibrated q graph.

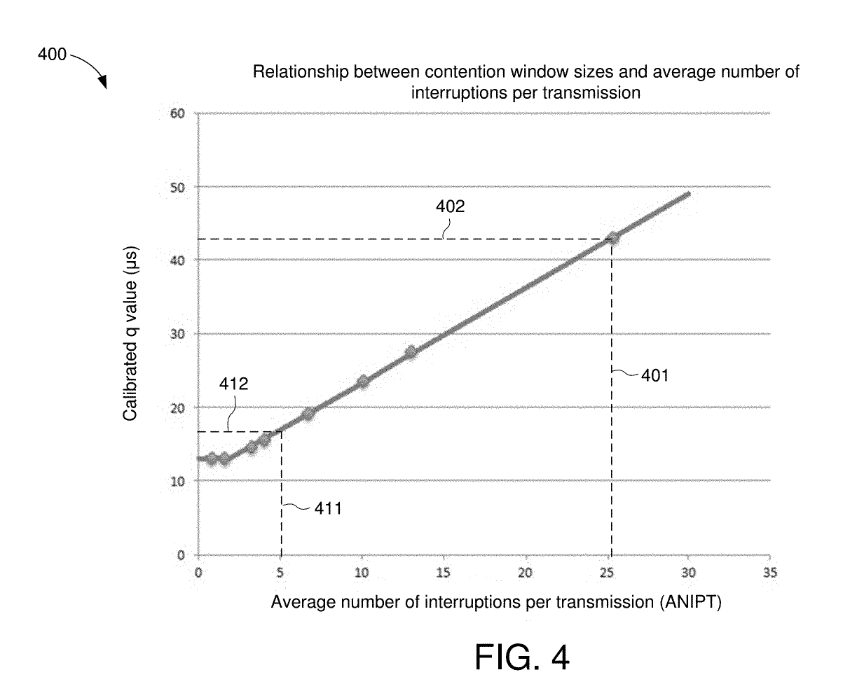

As mentioned above, for some implementations, the average number of interruptions per transmission (ANIPT) may be the selected success rate parameter. For example, FIG. 4 shows a calibrated q graph 400 depicting an example relationship between calibrated LBE contention window sizes (e.g., calibrated q values) and ANIPT values. As shown in FIG. 4, the calibrated q value increases as the average number of interruptions per transmission increases. More specifically, as the average number of interruptions per transmission increases (e.g., indicating an increasing level of contention on the shared wireless medium), the likelihood of EDCA devices employing an exponential backoff procedure also increases, which as discussed above may put EDCA devices at a disadvantage relative to LBE devices when contending for medium access.

Thus, in accordance with some aspects, the size of the contention window from which LBE device 300 selects a random backoff number for medium access contention operations may be adjusted (e.g., increased) based on the calibrated q graph 400. As described in more detail below, the LBE device 300 may increase its backoff period based, at least in part, on a selected calibrated q value so that medium access success rates for the LBE device 300 are the same (or at least similar) to the medium access success rate of EDCA devices. For example, in an implementation using the example calibrated q graph 400, if the average number of interruptions per transmission is a relatively high value of approximately 25, then a relatively high calibrated q value of approximately 42 μs may define the contention window size from which LBE device 300 selects its random backoff number for medium access contention operations (as indicated by lines 401-402).

Conversely, as shown in FIG. 4, the calibrated q value decreases as the average number of interruptions per transmission decreases. More specifically, as the average number of interruptions per transmission decreases (e.g., indicating a decreasing level of contention on the shared wireless medium), the likelihood of EDCA devices employing an exponential backoff procedure also decreases, which as discussed above may reduce the differences in medium access success rates between EDCA devices and LBE devices. For example, in an implementation using the example calibrated q graph 400, if the average number of interruptions per transmission is a relatively low value of approximately 5, then a relatively low calibrated q value of approximately 16 μs may define the contention window size from which LBE device 300 selects its random backoff number for medium access contention operations (as indicated by lines 411-412).

The calibrated q graph 400 of FIG. 4 may be determined by observing, for each of a plurality of ANIPT values, the medium access success rates of LBE devices compared to the medium access success rates of EDCA devices. More specifically, the value of q (e.g., the LBE contention window size) may be adjusted until the medium access success rates are the same (or at least similar) for both LBE devices and EDCA devices. The value of q that results in the same or similar medium access success rates for LBE and EDCA devices may be selected as the calibrated q value corresponding to a particular ANIPT value. The calibrated q values may be plotted as a function of the ANIPT values to generate the example calibrated q graph 400 of FIG. 4.

Thereafter, when contending for medium access, the LBE device 300 may measure, obtain, or otherwise determine an ANIPT value, and then select a corresponding calibrated q value from the calibrated q graph 400. The LBE device 300 may then use the selected calibrated q value (rather than the fixed q value) to define the contention window size from which to select a random backoff number for medium access contention operations.

For example, Table 1 below lists a number of example pairs of calibrated q values and ANIPT values from which the example calibrated q graph 400 of FIG. 4 may be determined.

TABLE 1

| Devices | ANIPT | Calibrated q (μs) |
|---|---|---|
| 2 | 0.9 | 13 |
| 3 | 1.7 | 13 |
| 5 | 3.3 | 14.5 |
| 6 | 4.1 | 15.5 |
| 10 | 6.8 | 19.0 |
| 15 | 10.1 | 23.5 |
| 20 | 13.1 | 27.5 |
| 40 | 25.3 | 43.0 |

More specifically, for some implementations, the pairs of calibrated q values and ANIPT values shown above in Table 1 may be used to determine a calibrated q value using the below expression (where “max{a, b}” equals the greater of a and b):

q_{calibrated}=max{13,10.4766+1.2852*ANIPT} (EQ. 4)

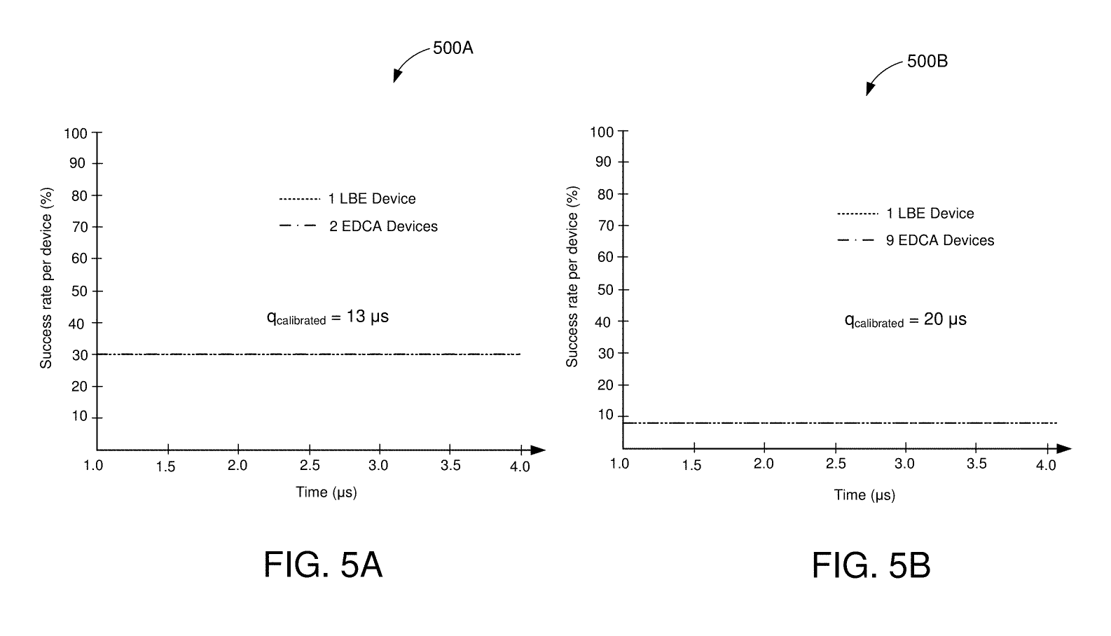

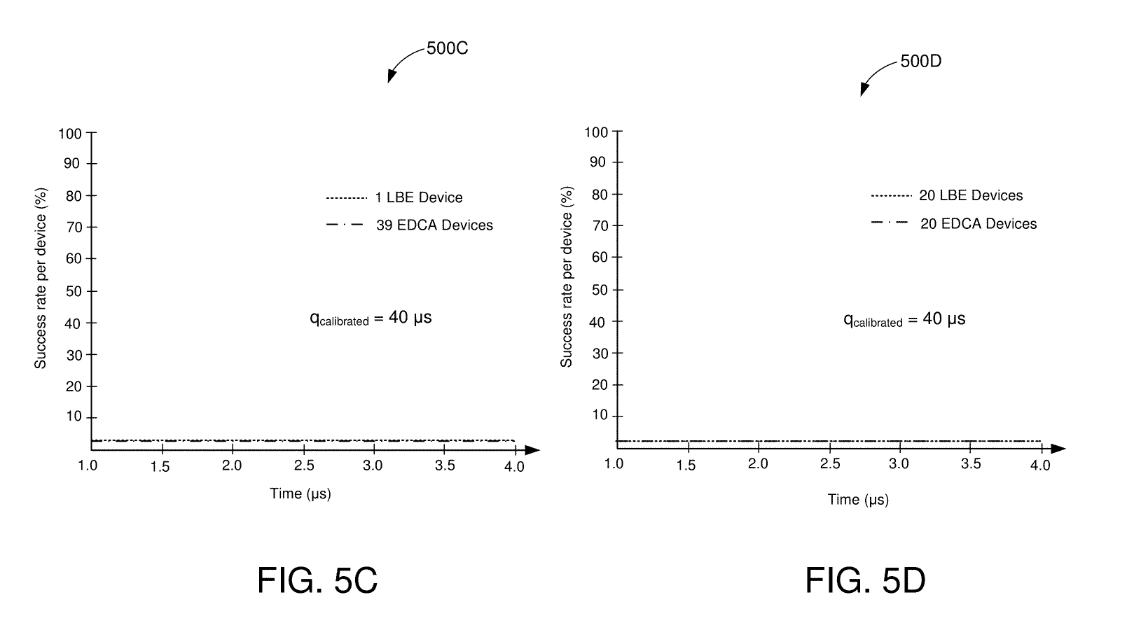

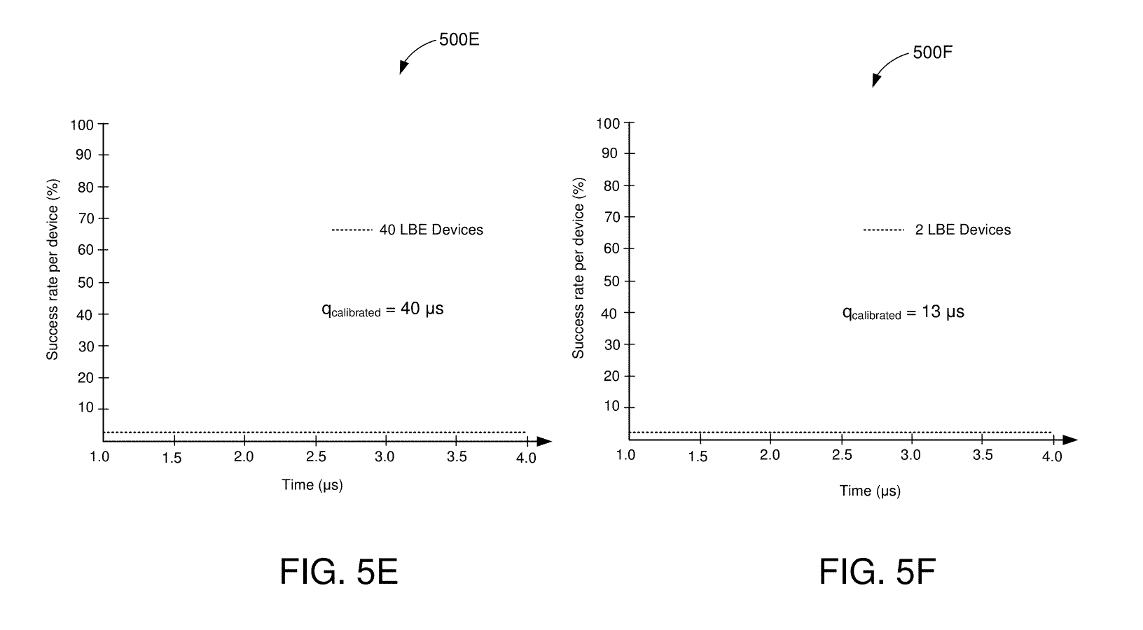

For one example, FIG. 5A shows an example graph 500A depicting example medium access success rates as a function of time for a wireless network including 1 LBE device and 2 EDCA devices contending for medium access. More specifically, the LBE device (not shown for simplicity) contends for medium access using a calibrated q value that may be determined in accordance with some aspects (e.g., as described above with respect to FIG. 4), and the EDCA devices (not shown for simplicity) contend for medium access using the EDCA backoff mechanism defined in the IEEE 802.11e standards. As depicted in FIG. 5A, the LBE device and the EDCA devices each have a medium access success rate of approximately 30%. The calibrated q value used by the LBE device in the example of FIG. 5A is approximately 13 μs.

For another example, FIG. 5B shows an example graph 500B depicting example medium access success rates as a function of time for a wireless network including 1 LBE device and 9 EDCA devices contending for medium access. More specifically, the LBE device (not shown for simplicity) contends for medium access using a calibrated q value that may be determined in accordance with some aspects (e.g., as described above with respect to FIG. 4), and the EDCA devices (not shown for simplicity) contend for medium access using the EDCA backoff mechanism defined in the IEEE 802.11e standards. As depicted in FIG. 5B, the LBE device and the EDCA devices each have a medium access success rate of approximately 10%. For the LBE device in the example of FIG. 5B, q_{calibrated}≈20 μs.

For another example, FIG. 5C shows an example graph 500C depicting example medium access success rates as a function of time for a wireless network including 1 LBE device and 39 EDCA devices contending for medium access. More specifically, the LBE device (not shown for simplicity) contends for medium access using a calibrated q value that may be determined in accordance with some aspects (e.g., as described above with respect to FIG. 4), and the EDCA devices (not shown for simplicity) contend for medium access using the EDCA backoff mechanism defined in the IEEE 802.11e standards. As depicted in FIG. 5C, the LBE device and the EDCA devices each have a medium access success rate of approximately 3%. For the LBE device in the example of FIG. 5C, q_{calibrated}≈40 μs.

For another example, FIG. 5D shows an example graph 500D depicting example medium access success rates as a function of time for a wireless network including 20 LBE devices and 20 EDCA devices contending for medium access. More specifically, the LBE devices (not shown for simplicity) contend for medium access using a calibrated q value that may be determined in accordance with some aspects (e.g., as described above with respect to FIG. 4), and the EDCA devices (not shown for simplicity) contend for medium access using the EDCA backoff mechanism defined in the IEEE 802.11e standards. As depicted in FIG. 5D, the LBE devices and the EDCA devices each have a medium access success rate of approximately 3%. For the LBE devices in the example of FIG. 5D, q_{calibrated}≈40 μs.

For another example, FIG. 5E shows an example graph 500E depicting example medium access success rates as a function of time for a wireless network including 40 LBE devices contending for medium access. More specifically, the LBE devices (not shown for simplicity) contend for medium access using a calibrated q value that may be determined in accordance with some aspects (e.g., as described above with respect to FIG. 4) As depicted in FIG. 5E, the LBE devices each have a medium access success rate of approximately 3%. For the LBE devices in the example of FIG. 5E, q_{calibrated}≈40 μs.

For another example, FIG. 5F shows an example graph 500F depicting example medium access success rates as a function of time for a wireless network including 2 LBE devices contending for medium access. More specifically, the LBE devices (not shown for simplicity) contend for medium access using a calibrated q value that may be determined in accordance with some aspects (e.g., as described above with respect to FIG. 4) As depicted in FIG. 5F, the LBE devices each have a medium access success rate of approximately 3%. For the LBE devices in the example of FIG. 5F, q_{calibrated}≈13 μs.

The example graphs 500A-500F depicted in FIGS. 5A-5F, respectfully, correspond to calibrated q values determined using a damping factor (DF) set to 90% and using a moderation factor (MF) set to 10%. For other embodiments, other values for the damping factor (DF) and the moderation factor (MF) may be used. For example, as described above, increasing the values of the damping factor (DF) and the moderation factor (MF) may increase the rate with which the value of q is adjusted towards a target value (which may also increase jitter), while decreasing the values of the damping factor (DF) and the moderation factor (MF) may decrease the rate with which the value of q is adjusted towards the target value (which may reduce jitter).

Referring to FIGS. 5A-5F, the example embodiments may achieve the same (or at least similar) medium access success rates for LBE devices and EDCA devices regardless of the number of LBE devices or EDCA devices, for example, by selecting an appropriate calibrated q value (q_{calibrated}). Further, for at least some embodiments, the calibrated q value may be related to the total number of devices contending for medium access (e.g., rather than to the particular combination of LBE and EDCA devices). More specifically, in the examples of FIGS. 5A and 5F, which include 3 contending devices and 2 contending devices, respectively, similar medium access success rates between the LBE devices and the EDCA devices may be achieved with q_{calibrated}≈13 μs. In the example of FIG. 5B, which includes 10 contending devices, similar medium access success rates between the LBE devices and the EDCA devices may be achieved with q_{calibrated}≈20 μs. In the examples of FIGS. 5C-5E, which each include 40 contending devices, similar medium access success rates between the LBE devices and the EDCA devices may be achieved with q_{calibrated}≈40 μs.

Using the ANIPT as the success rate parameter upon which to determine calibrated q values that result in the same or similar medium access success rates for LBE and EDCA devices may also allow selected q values to be modified based on the number of contending devices. More specifically, if one or more selected q values (e.g., determined in the manner described above with respect to FIG. 4) do not result in the same or similar medium access success rates for LBE and EDCA devices, then a relationship between q offset values and ANIPT values may be used to converge the selected q values to calibrated q values that result in the same or similar medium access success rates. For some aspects described herein, the q offset value may increase as the number of contending devices decreases, and may decrease as the number of contending devices increases. Thus, the rate with which a given q value may converge to a corresponding calibrated q value may be faster for wireless networks having a relatively small number of contending devices than for wireless networks having a relatively large number of contending devices.

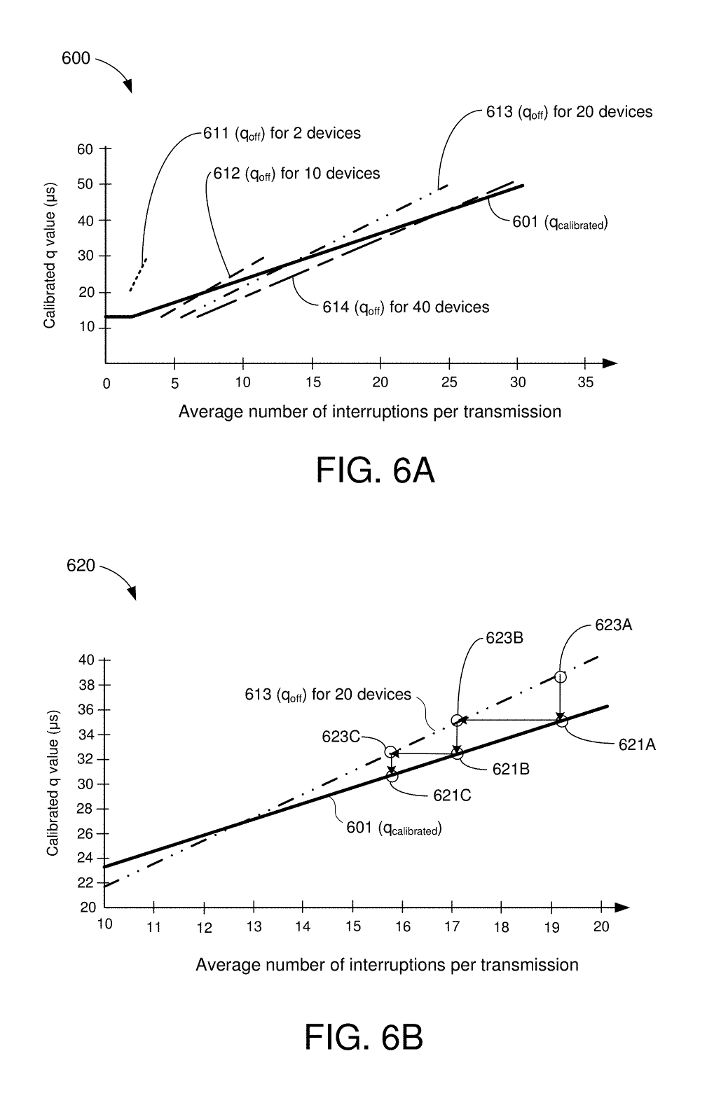

FIG. 6A shows a graph 600 depicting an example relationship between calibrated q values and ANIPT values relative to example relationships between q offset values and ANIPT values for various numbers of contending devices. A calibrated q graph 601 depicting calibrated q values (q_{calibrated}) as a function of ANIPT values may be determined in the manner described above with respect to FIG. 4. In some environments, a selected q value that defines the LBE contention window size may not result in LBE devices having the same (or similar) medium access success rates as EDCA devices. For example, a first q offset value plot 611 depicts q offset values (q_{offset}) as a function of ANIPT values for a wireless network including 2 contending devices, a second q offset value plot 612 depicts q offset values as a function of ANIPT values for a wireless network including 10 contending devices, a third q offset value plot 613 depicts q offset values as a function of ANIPT values for a wireless network including 20 contending devices, and a fourth q offset value plot 614 depicts q offset values as a function of ANIPT values for a wireless network including 40 contending devices.

The example q offset value plots 611-614 of FIG. 6A may be used to converge a given q value to a corresponding calibrated q value that results in the same (or similar) medium access success rates for both LBE devices and EDCA devices. For example, FIG. 6B depicts an example operation 620 for converging the value of q to the calibrated q value using the third q offset value plot 613 corresponding to 20 contending devices. The operation 620 of FIG. 6B may be based on the calibrated q graph 601 of FIG. 6A. For any given point on the q offset value plot 613, converging the value of q to a corresponding point on the calibrated q graph 601 may result in a decrease in the value of ANIPT. For one example, for an ANIPT value of approximately 19, the value of q may be incorrectly set to approximately 39 μs (as indicated by point 623A on the q offset value plot 613), whereas the corresponding calibrated q value is approximately 35 μs (as indicated by point 621A on the calibrated q graph 601). Thus, for an ANIPT value of approximately 19, the value of q is approximately 4 μs offset from the calibrated q value. For another example, for an ANIPT value of approximately 17, the value of q may be incorrectly set to approximately 35 μs (as indicated by point 623B on the q offset value plot 613), whereas the corresponding calibrated q value is approximately 32 μs (as indicated by point 621B on the calibrated q graph 601). Thus, for an ANIPT value of approximately 17, the value of q is approximately 3 μs offset from the calibrated q value. For yet another example, for an ANIPT value of approximately 16, the value of q may be incorrectly set to approximately 33 μs (as indicated by point 623C on the q offset value plot 613), whereas the corresponding calibrated q value is approximately 30 μs (as indicated by point 621C on the calibrated q graph 601). Thus, for an ANIPT value of approximately 16, the value of q is approximately 3 μs offset from the calibrated q value.

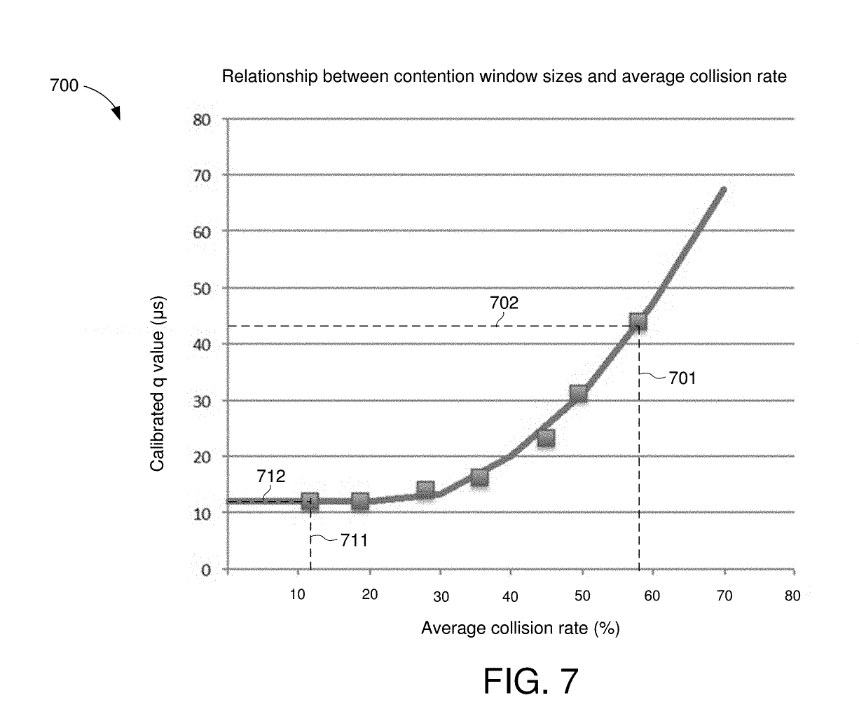

As mentioned above, for other implementations, the average collision rate may be the selected success rate parameter. For example, FIG. 7 shows a calibrated q graph 700 depicting an example relationship between calibrated q values and the average collision rate on a shared wireless medium during medium access contention operations. As shown in the example calibrated q graph 700 of FIG. 7, the calibrated q value increases as the average collision rate increases. More specifically, as the average collision rate increases (e.g., indicating an increasing level of contention on the shared wireless medium), the likelihood of EDCA devices employing an exponential backoff procedure also increases, which as discussed above may put EDCA devices at a disadvantage relative to LBE devices when contending for medium access.

Thus, in accordance with some aspects, the size of the contention window from which LBE device 300 selects a random backoff number for medium access contention operations may be adjusted (e.g., increased) based on the calibrated q graph 700. In this manner, the LBE device 300 may increase its backoff period based, at least in part, on a selected calibrated q value so that medium access success rates for the LBE device 300 are the same (or at least similar) to the medium access success rate of EDCA devices. For example, in an implementation using the example calibrated q graph 700, if the average collision rate is a relatively high value of approximately 58, then a relatively high calibrated q value of approximately 43 μs may define the contention window size from which LBE device 300 selects its random backoff number for medium access contention operations (as indicated by lines 701-702).

Conversely, as shown in FIG. 7, the calibrated q value decreases as the average collision rate decreases. More specifically, as the average collision rate decreases (e.g., indicating a decreasing level of contention on the shared wireless medium), the likelihood of EDCA devices employing an exponential backoff procedure also decreases, which as discussed above may reduce the differences in medium access success rates between EDCA devices and LBE devices. For example, in an implementation using the example calibrated q graph 700, if the average collision rate is a relatively low value of approximately 11, then a relatively low calibrated q value of approximately 11 μs may define the contention window size from which LBE device 300 selects its random backoff number for medium access contention operations (as indicated by lines 711-712).

The calibrated q graph 700 of FIG. 7 may be determined by observing, for a given number of devices, the medium access success rates of LBE devices compared to EDCA devices. Then, the value of q (e.g., the LBE contention window size) may be adjusted until the medium access success rates are the same (or at least similar) for LBE devices and EDCA devices. The resultant value of q may then be designated as the calibrated q value. The calibrated q values may be plotted as a function of the moving average of the collision rate, for example, to generate the example calibrated q graph 700 of FIG. 7.

Thereafter, when an LBE device 300 is contending for medium access, the LBE device 300 may measure, obtain, or otherwise determine the average collision rate, and then select a corresponding calibrated q value from the calibrated q graph 700. The LBE device 300 may then use the selected calibrated q value (rather than the fixed q value) to define the contention window size from which to select a random backoff number for medium access contention operations.

For example, Table 2 below lists a number of example pairs of calibrated q values and average collision rates (ACRs) from which the example calibrated q graph 700 of FIG. 7 may be determined.

TABLE 2

| Devices | ACR | Calibrated q (μs) |
|---|---|---|
| 2 | 0.12 | 12 |
| 3 | 0.19 | 12 |
| 6 | 0.28 | 14 |
| 15 | .45 | 23 |
| 20 | 0.5 | 31 |
| 40 | 0.58 | 44 |

More specifically, for some implementations, the pairs of calibrated q values and ACR values shown above in Table 2 may be used to determine the value of q_{target} using the below expression (where “max{a,b} equals the greater of a and b):

if ACR<0.21, then q_{target}=12 (EQ. 5)

else q_{target}=max{12, 229.9096*ACR²−94.3678*ACR+2.8437}

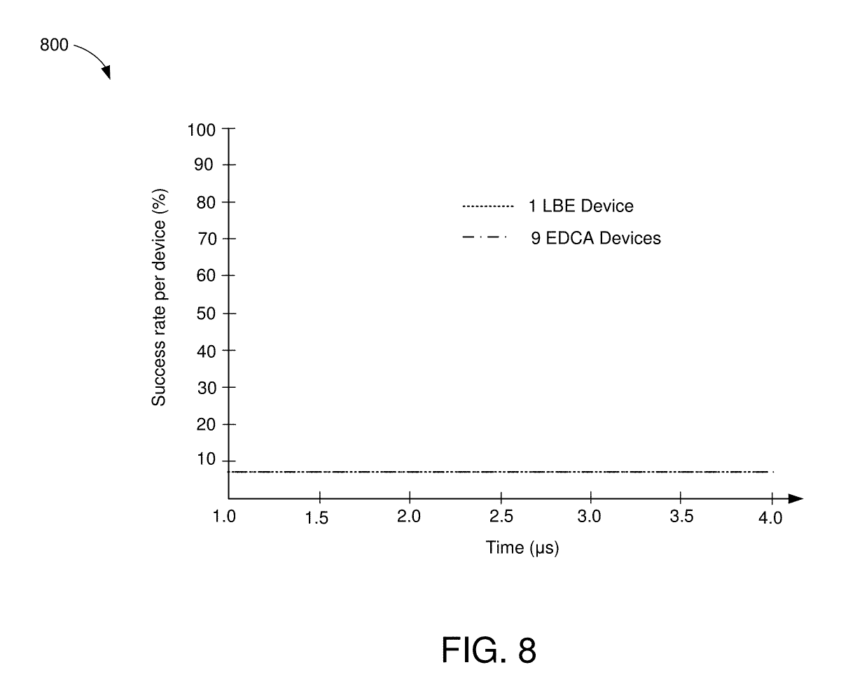

FIG. 8 shows an example graph 800 depicting example medium access success rates as a function of time for a wireless network including 1 LBE device and 9 EDCA devices contending for medium access. More specifically, the 1 LBE device (not shown for simplicity) contends for medium access using a calibrated q value that may be determined in accordance with some aspects (e.g., as described above with respect to FIG. 7), and the EDCA devices (not shown for simplicity) contend for medium access using the EDCA backoff mechanism. As depicted in FIG. 8, the 1 LBE device and the 9 EDCA devices each have a medium access success rate of approximately 8%. For the example of FIG. 8, the damping factor is set to 90% and the moderation factor is set to 10%.

As mentioned above, for other implementations, the average time between medium busy events on the shared wireless medium may be the selected success rate parameter. For such implementations, determination of calibrated q values may also be based upon additional information such as, for example, a number of different observed MAC addresses, a histogram of different observed modulation and coding schemes (MCSs), and/or received signal strength indicator (RSSI) values.

FIG. 9 shows an illustrative flowchart depicting an example operation 900 for ensuring equal medium access between a first wireless device associated with a load based equipment (LBE) protocol and a number of second wireless devices associated with an enhanced distributed channel access (EDCA) protocol. As discussed above, the LBE protocol may be defined by a European Telecommunications Standards Institute (ETSI) Broadband Access Network (BRAN) for LBE standard, and may prescribe a fixed contention window size for all medium access contention operations regardless of collisions. The EDCA protocol may be defined by the IEEE 802.11(e) standard, and may prescribe doubling the contention window size for each subsequent medium access contention operation resulting from collisions on the wireless medium.

For the example of FIG. 9, the first wireless device may be LBE device 300 of FIG. 3, and one or more of the second wireless devices may be EDCA device 200 of FIG. 2. Thus, as described above, the first wireless device may be associated with a channel access mechanism that maintains a fixed contention window size for medium access contention operations regardless of collisions, and the second wireless devices may be associated with a channel access mechanism that employs an exponential backoff procedure in the event of collisions.

The first wireless device may determine a level of contention associated with gaining access to a wireless medium (902). For some implementations, to determine the level of contention, the first wireless device may select a parameter indicative of a medium access success rate of the first wireless device (902A), and may then determine a moving average of the selected parameter, the moving average indicative of the level of contention (902B). The level of contention may indicate traffic levels on the wireless medium, congestion levels on the wireless medium, a likelihood of gaining medium access, and/or the number of devices contending for medium access. As discussed above, the selected parameter, which may indicate a medium access success rate, may be (i) the average number of interruptions per transmission, (ii) the average collision rate, or (iii) the average time between medium busy events.

The first wireless device may then select a contention window size based, at least in part, on the determined level of contention (904). For some implementations, to select the contention window size, the first wireless device may retrieve, from a memory, a calibrated contention window size value corresponding to the determined moving average (904A), and then define the selected contention window size based on the retrieved calibrated contention window size value (904B). As discussed above, the memory may store, for each of a plurality of moving averages of the selected parameter, a corresponding calibrated contention window size value that, when used to define the contention window size, results in similar medium access success rates for the first wireless device and the number of second wireless devices. In some aspects, the memory may store the calibrated q graph of FIG. 4 and/or the calibrated CW size graph of FIG. 7.

Next, the first wireless device may select, for a medium access contention operation, a random backoff number from a range of numbers defined by the selected contention window size (906). As discussed above, selecting the random backoff number from the range of numbers defined by the selected contention window size may ensure that LBE devices and EDCA devices have the same or similar medium access success rates. For some aspects, the EDCA devices may not alter their contention window sizes, and adhere to the exponential backoff procedure defined, for example, in the IEEE 802.11e standards.

As described above, for at least some embodiments, the first wireless device may decrease a slot time used for medium access contention operations and/or may increase its backoff period by a duration (908). In some aspects, the duration may be an Arbitration Interframe Space (AIFS) duration. In other aspects, the duration may be a number of SIFS durations, a number of PIFS durations, a DIFS duration, or any other suitable time period.

Thereafter, the first wireless device may dynamically adjust the selected contention window size based on changes in the level of contention (910). For example, after selecting the contention window size, the first wireless device may continue monitoring the wireless medium to detect changes in contention levels, and in response thereto may dynamically adjust the contention window size to ensure continued fairness between LBE devices and EDCA devices for medium access contention operations.

For other embodiments, the size of the contention window (CW) from which EDCA device 200 selects its random backoff number may be adjusted so that LBE devices and EDCA devices have the same or similar medium access success rates (e.g., rather than adjusting the size of the contention window used by the LBE devices). For example, the EDCA device 200 may determine a level of contention associated with gaining access to a wireless medium, may select a contention window size based, at least in part, on the determined level of contention, and may select a random backoff number from a range of numbers defined by the selected contention window size.

More specifically, in accordance with some aspects, the CW size associated with EDCA device 200 may be adjusted based on observed collisions, transmission interruptions, and/or inter-CCA (clear channel assessment) busy times in a manner that ensures that LBE devices and EDCA devices have equal chances of gaining medium access. In some aspects, the EDCA device 200 may maintain a moving average of one or more success rate parameters such as, for example, (i) the average number of interruptions per transmission, (ii) the average collision rate, and (iii) the average time between medium busy events. For some implementations, the moving average (MA) may be determined as a simple (e.g., unweighted) moving average, for example, as described above with respect to EQ. 1. For other implementations, the moving average MA may be determined as a weighted moving average, for example, using a damping factors (DF) as described above with respect to EQ. 2 and/or using a moderation factor (MF) as described above with respect to EQ. 3.

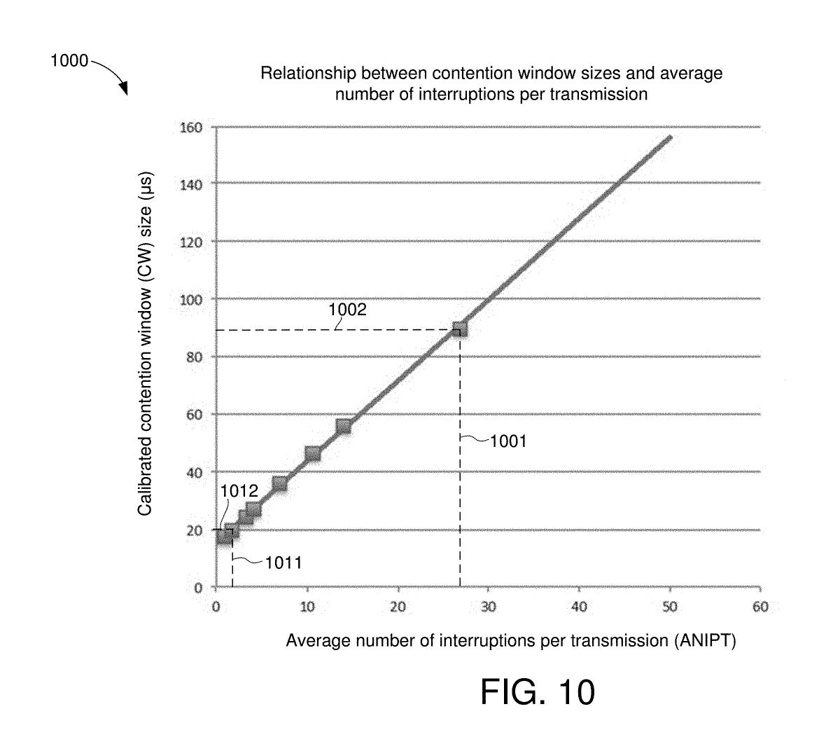

FIG. 10 shows a calibrated CW size graph 1000 depicting an example relationship between calibrated CW sizes and the average number of interruptions per transmission (ANIPT). As shown in the example calibrated CW size graph 1000 of FIG. 10, the calibrated CW size increases as the average number of interruptions per transmission increases. More specifically, as the average number of interruptions per transmission increases (e.g., indicating an increasing level of contention on the shared wireless medium), the size of the contention window from which EDCA device 200 selects a random backoff number for medium access contention operations may be adjusted (e.g., increased) based on the example calibrated CW size graph 1000. In this manner, the EDCA device 200 may increase its backoff period based, at least in part, on the selected calibrated CW size so that medium access success rates for EDCA devices are the same (or at least similar) as the medium access success rates for LBE devices. For example, in an implementation using the example calibrated CW size graph 1000, if the average number of interruptions per transmission is a relatively high value of approximately 26, then a relatively high CW size of approximately 90 μs may define the contention window size from which EDCA device 200 selects its random backoff number for medium access contention operations (as indicated by lines 1001-1002).

Conversely, as shown in FIG. 10, the calibrated CW size decreases as the average number of interruptions per transmission decreases. More specifically, as the average number of interruptions per transmission decreases (e.g., indicating a decreasing level of contention on the shared wireless medium), the likelihood of EDCA devices employing an exponential backoff procedure also decreases, which as discussed above may reduce the differences in medium access success rates between EDCA devices and LBE devices. In this manner, the EDCA device 200 may decrease the size of the contention window from which the random backoff number is selected, which in turn may decrease the backoff period of EDCA device 200, for example, so that medium access success rates for the EDCA device 200 are the same (or at least similar) as the medium access success rates for LBE devices. For example, in an implementation using the example calibrated CW size graph 1000, if the average number of interruptions per transmission is a relatively low value of approximately 2, then a relatively low CW size of approximately 20 μs may define the contention window size from which EDCA device 200 selects its random backoff number for medium access contention operations (as indicated by lines 1011-1012).

Thus, while typical EDCA devices use a CW size that is initially set to a fixed minimum value (e.g., CWₘᵢₙ) and then doubled for each subsequent medium access contention operation, EDCA devices of the example embodiments may dynamically adjust the CW size based, at least in part, on the ANIPT (e.g., rather than employing an exponential backoff procedure).

The calibrated CW size graph 1000 of FIG. 10 may be determined by observing, for a given number of devices, the medium access success rates of EDCA devices compared to LBE devices. Then, the size of the CW from which EDCA device 200 selects its random backoff number may be adjusted until the medium access success rates are the same (or at least similar) for LBE devices and EDCA devices. The resultant CW size may then be designated as the calibrated CW size. A number of calibrated CW sizes may be plotted as a function of the moving average of the number of interruptions per transmission, for example, to generate the example calibrated CW size graph 1000 depicted in FIG. 10.

Thereafter, when EDCA device 200 is contending for medium access, the EDCA device 200 may measure, obtain, or otherwise determine an ANIPT value, and then select a corresponding calibrated CW size from the calibrated CW size graph 1000. The EDCA device 200 may then use the selected calibrated CW size from which to select a random backoff number for medium access contention operations (e.g., rather than using an exponential backoff procedure).

For example, Table 3 below lists a number of example pairs of calibrated CW sizes and ANIPT values from which the example calibrated CW size graph 1000 of FIG. 10 may be determined.

TABLE 3

| Devices | ANIPT | Calibrated Average CW (μs) |
|---|---|---|
| 2 | 0.8904 | 17.1100 |
| 3 | 1.7252 | 19.4089 |
| 5 | 3.3118 | 24.2900 |
| 6 | 4.0809 | 26.6754 |
| 10 | 7.0437 | 35.7292 |
| 15 | 10.5701 | 46.2671 |
| 20 | 14.0023 | 55.6873 |
| 40 | 26.8387 | 89.7851 |

More specifically, for some implementations, the pairs of calibrated average CW sizes and the ANIPT values shown above in Table 3 may be used to determine the calibrated CW size (CW calibrated) using the below expression:

CW_{calibrated}=2.8150*ANIPT+15.2782 (EQ. 7)

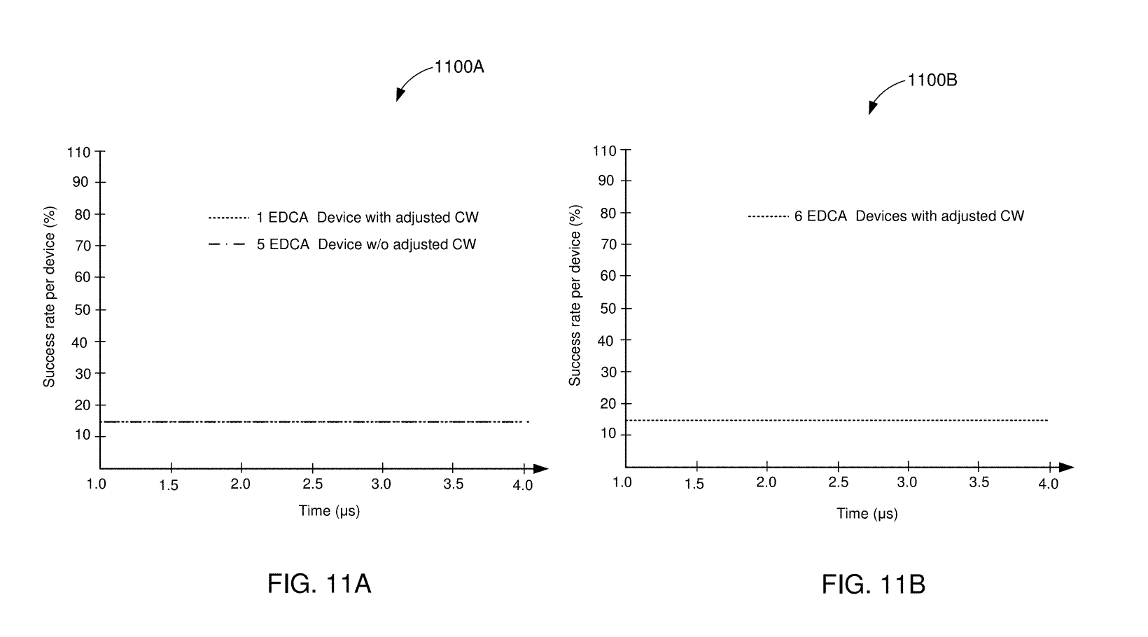

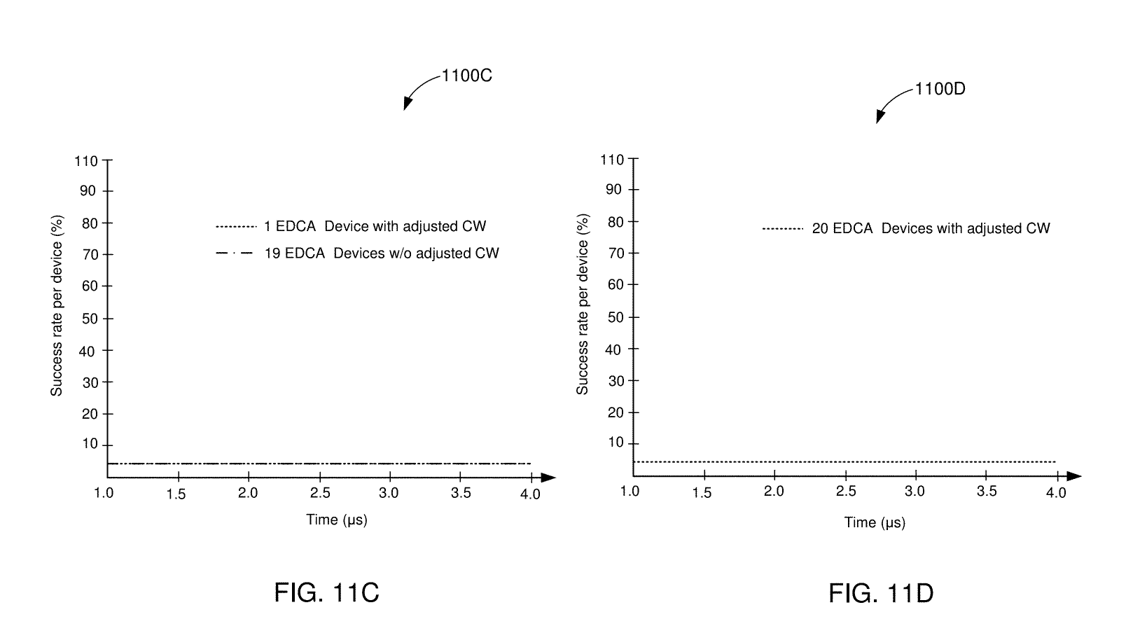

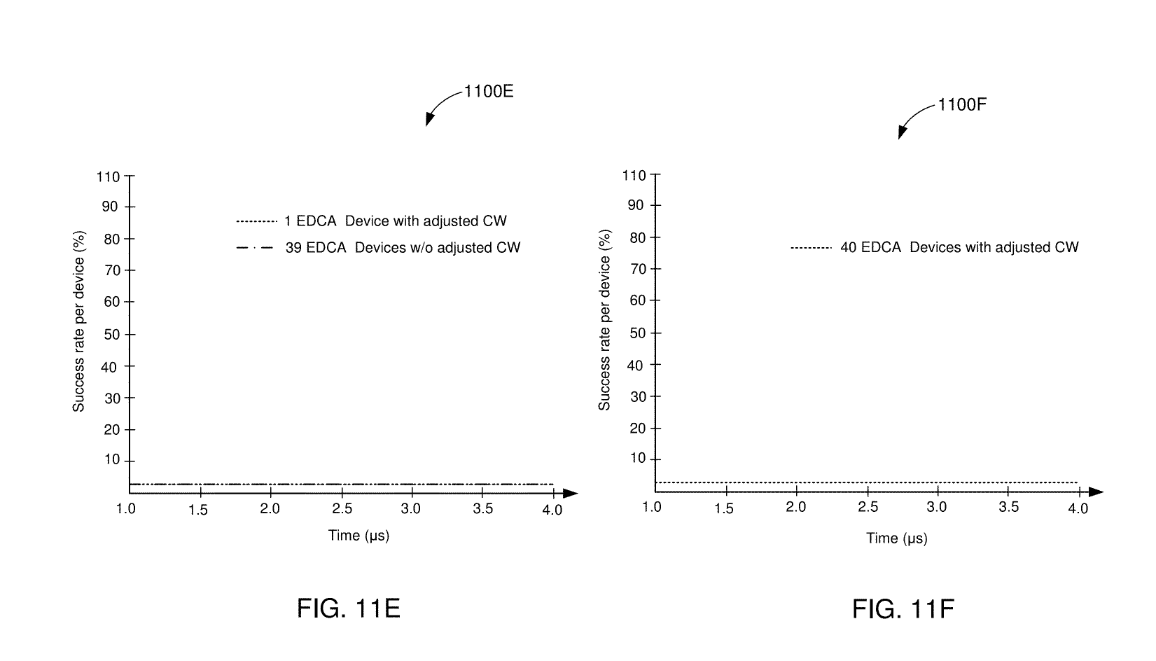

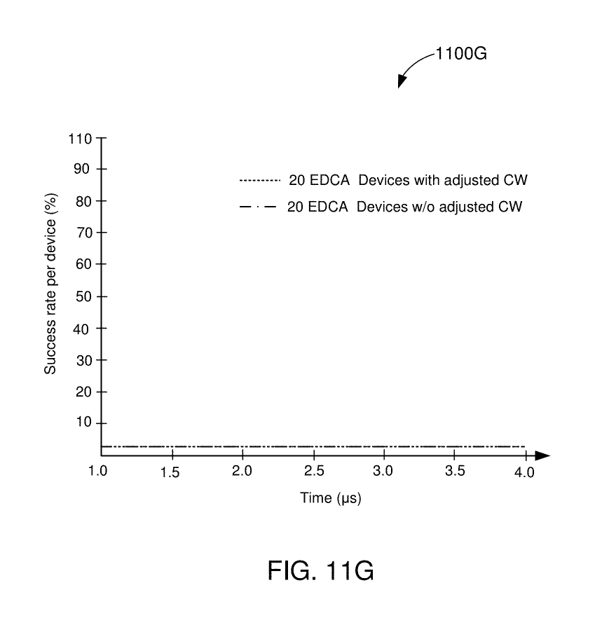

For one example, FIG. 11A shows an example graph 1100A depicting example medium access success rates as a function of time for a wireless network including 1 EDCA device that dynamically adjusts its CW size (e.g., based at least in part on one or more measured ANIPT values) and 5 EDCA devices that do not dynamically adjust their CW sizes (e.g., 5 EDCA devices that use an exponential backoff procedure as defined by the IEEE 802.11e standards). As depicted in FIG. 11A, all contending EDCA devices have a medium access success rate of approximately 15%.

For another example, FIG. 11B shows an example graph 1100B depicting example medium access success rates as a function of time for a wireless network including 6 EDCA devices that dynamically adjust their CW sizes (e.g., based at least in part on one or more measured ANIPT values). As depicted in FIG. 11B, all contending EDCA devices have a medium access success rate of approximately 15%.

For another example, FIG. 11C shows an example graph 1100C depicting example medium access success rates as a function of time for a wireless network including 1 EDCA device that dynamically adjusts its CW size (e.g., based at least in part on one or more measured ANIPT values) and 19 EDCA devices that do not dynamically adjust their CW sizes. As depicted in FIG. 11C, all contending EDCA devices have a medium access success rate of approximately 5%.

For another example, FIG. 11D shows an example graph 1100D depicting example medium access success rates as a function of time for a wireless network including 20 EDCA devices that dynamically adjust their CW sizes (e.g., based at least in part on one or more measured ANIPT values). As depicted in FIG. 11D, all contending EDCA devices have a medium access success rate of approximately 5%.

For another example, FIG. 11E shows an example graph 1100E depicting example medium access success rates as a function of time for a wireless network including 1 EDCA device that dynamically adjusts its CW size (e.g., based at least in part on one or more measured ANIPT values) and 39 EDCA devices that do not dynamically adjust their CW sizes. As depicted in FIG. 11E, all contending EDCA devices have a medium access success rate of approximately 4%.

For another example, FIG. 11F shows an example graph 1100F depicting example medium access success rates as a function of time for a wireless network including 40 EDCA devices that dynamically adjust their CW sizes (e.g., based at least in part on one or more measured ANIPT values). As depicted in FIG. 11F, all contending EDCA devices have a medium access success rate of approximately 4%.

For another example, FIG. 11G shows an example graph 1100G depicting example medium access success rates as a function of time for a wireless network including 20 EDCA devices that dynamically adjust their CW sizes (e.g., based at least in part on one or more measured ANIPT values) and 20 EDCA devices that do not dynamically adjust their CW sizes. As depicted in FIG. 11G, all contending EDCA devices have a medium access success rate of approximately 4%.

The example graphs 1100A-1100G depicted in FIGS. 11A-11G, respectfully, correspond to calibrated CW sizes determined using a damping factor (DF) set to 90% and using a moderation factor (MF) set to 10%. For other embodiments, other values for the damping factor (DF) and the moderation factor (MF) may be used.

For some implementations, a relationship between the number of actively contending devices (n) and a selected parameter (e.g., one of the average number of interruptions per transmission (ANIPT), the average collision rate (ACR), and the inter-CCA busy time (t_{busy})) may be used to verify that a particular wireless device is operating according to a specified medium access contention mechanism (e.g., EDCA with a truncated exponential backoff procedure). The particular device, which may hereinafter be referred to as the device-under-test (DUT), may be provided within a test network (either real or simulated), and the selected parameter as observed by the DUT may be verified as having the correct value, for the number of actively contending devices, that results in the same or similar medium access success rates for LBE and EDCA devices. In some aspects, if the selected parameter value cannot be observed by other devices not under test, then the observed parameter value at a test network node may be used to verify that the selected parameter value is within a range of the correct value for the number of actively contending devices.

An example first order relationship between the number of actively contending devices (n) and the average number of interruptions per transmission (ANIPT) may be expressed as ANIPT=0.9+0.6n. An example second order relationship between the number of actively contending devices (n) and ANIPT may be expressed as ANIPT=−0.0019n²+0.731n−0.229.

An example first order relationship between the number of actively contending devices (n) and the number of interruptions per successful TXOP (ANIPST) may be expressed as ANIPST=1.80n−6.4. An example second order relationship between the number of actively contending devices (n) and ANIPST may be expressed as ANIPST=0.0072n²+1.3386n−2.0871.

An example relationship between the number of actively contending devices (n) and the average collision probability (ACP) may be expressed as ACP=0.23+0.014n−0.0001n².

An example relationship between t_{busy} and the calibrated contention window size used by EDCA devices may be expressed as CW_{calibrated}=(8/(0.02*t_{busy}−1)) slots.

An example relationship between the average number of interruptions per transmission (ANIPT) and the EDCA contention window size may be expressed as CW_{calibrated}=(15+3.2*ANIPT) slots. Another example relationship between the average number of interruptions per transmission (ANIPT) and the EDCA contention window size may be expressed as CW_{calibrated}=(17+2.7*ANIPT) slots. Yet another example relationship between the average number of interruptions per transmission (ANIPT) and the EDCA contention window size may be expressed as CW_{calibrated}=−0.013*ANIPT²+3.22*ANIPT+13.92.

An example second order relationship between the average collision probability (ACP) observed at the DUT and the EDCA contention window size may be expressed as CW_{calibrated}=(60−290ACP+588ACP²) slots. An example exponential relationship between the average collision probability (ACP) observed at the DUT and the EDCA contention window size may be expressed as CW_{calibrated}=7.2836*ê(4.2865*ACP) slots.

In some embodiments, the inverse of a relationship between the number of actively contending devices and the value of a selected parameter as observed by a wireless device may be used to estimate the number of actively contending devices. The estimated number of actively contending devices (or the observed value of the selected parameter) may be used to adjust the limit of a maximum TXOP duration. In some aspects, the maximum TXOP duration may be increased as the number of actively contending devices decreases, and may be decreased as the number of actively contending devices increases.

For other implementations, device compliance may be verified by determining that an average contention window size CW_{average}=16.51+1.978n−0.0056n̂2 and/or that the average number of interruptions per transmission ANIPT=−0.0019*n²+0.731*n−0.229, where n is the number of devices simultaneously contending for medium access. The ANIPT value may be approximately equal to one less than the number of AIFS durations within the backoff period that resulted in a TXOP.

For other embodiments, device compliance may be verified by providing the device under test (DUT) and a testbed device (TD) within a wireless network. The TD may be a device employing an exponential backoff procedure for which CWₘᵢₙ=CWₘₐₓ. For one example, setting CWₘᵢₙ=CWₘₐₓ=6 slots may emulate the presence of 5 actively contending devices. For another example, setting CWₘᵢₙ=CWₘₐₓ=4 slots may emulate the presence of 7 actively contending devices. For yet another example, setting CWₘᵢₙ=CWₘₐₓ=2 slots may emulate the presence of 17 actively contending devices. The TD may count the number of interruptions during the backoff period (which represents successful TXOPs for the DUT) to verify that the DUT complies with a target ANIPT value. For example, deriving the target ANIPT value as ANIPT_{target}=−0.0019*n²+0.731*n−0.229 may generate the values summarized below in Table 4:

TABLE 4

| TD CWmin = CWmax | 6 | 4 | 2 |
|---|---|---|---|
| Effective number of emulated nodes | 5 | 7 | 17 |
| DUT success rate | 0.19 | 0.11 | 0.03 |
| DUT average CW (slots) | 22.87 | 29.52 | 58.47 |
| DUT ACP | 0.25 | 0.34 | 0.50 |
| DUT ANIPT | 2.86 | 4.90 | 14.55 |
| DUT Interruptions per successful TXOP | 4.18 | 7.88 | 30.32 |
| Average backoff between TXOPs (μs) | 63.03 | 57.96 | 51.43 |

A fixed backoff period may also be employed by the TD. More specifically, if a fixed backoff period is employed by the TD, the TD may determine a probability distribution for ANIPT, for example, to characterize the degree of randomness at the DUT.

For yet other embodiments, device compliance may be verified by determining that the success rate at the TD is higher than a success rate threshold level (SR_{threshold}). The value of SR_{threshold} may be determined by adding a reference device as the DUT in the test network, and then measuring the medium access success rate at the TD for the protocol-defined CW size and/or for a number of calibrated CW sizes. The medium access success rate at the TD may be determined to equal or correlate to the number of successful transmission attempts by the TD relative to the total number of transmission attempts at the TD. For one example, using a contention window size of 5 slot times (e.g., corresponding to the level of contention associated with approximately 7 EDCA devices), SR_{threshold}≈0.78 (on a scale between 0 and 1). For another example, using a contention window size of 2 slot times (e.g., corresponding to the level of contention associated with approximately 17 EDCA devices), SR_{threshold}≈0.94 (on a scale between 0 and 1).

For still other embodiments, device compliance may be verified by determining that the medium access success rate per second at the TD is higher than the value of SR_{threshold}. For such embodiments, the value of SR_{threshold} may be determined by adding a reference device as the DUT to the test network, and then measuring the medium access success rate per second at the TD for the protocol-defined CW size and/or for a number of calibrated CW sizes. The medium access success rate per second may be defined as the number of successful transmission attempts by the TD per second.

In some aspects, the TD may switch to a smaller CW size during the test. An average value for SR_{threshold} during the test may be determined by using the reference device as the DUT. More specifically, a DUT that reacts too slowly to the increased contention intensity (e.g., resulting from the smaller CW size) may fail the test.

As described above, LBE devices and/or EDCA devices may adjust the contention window size from which random backoff numbers are selected based on one or more selected success rate parameters. For other embodiments, LBE devices and/or EDCA devices may adjust their contention window sizes based on an observed success rate parameter and a doubling probability (P_{double}). The doubling probability may be used to selectively double the contention window size and/or to reset contention window size. In some aspects, the doubling probability may indicate the probability of collisions in a wireless network including devices that employ an exponential backoff procedure, and its use may hereinafter be referred to as the “exponential front end technique.” As explained in more detail below, while conventional exponential backoff procedures (e.g., as defined in the IEEE 802.11e standards) automatically double the contention window size for each subsequent medium access contention operation, the exponential front end technique disclosed herein selectively doubles or resets (e.g., to CWₘᵢₙ) the contention window size based on the doubling probability (P_{double}). In some aspects, the value of P_{double} may be determined in response to an observed success rate parameter (rather than in response to actual collisions during medium access contention operations).

More specifically, in accordance with the exponential front end techniques disclosed herein, a wireless device may double the CW size with a probability indicated by P_{double} until the CW size reaches CWₘₐₓ, and may reset the CW size to CWₘᵢₙ with a probability indicated by (1−P_{double}). In addition or as an alternative, the wireless device may reset the CW size to CWₘᵢₙ when the number of medium access “retries” reaches a limit. As used herein, the number of medium access retries may be defined as the number of consecutive medium access contention operations for which the CW size is doubled.

An example relationship between the gap time (t_{busy}) and P_{double} may be expressed as P_{double}=0.000591*t_{busy}̂2−0.0915*t_{busy}+3.649. An example relationship between the ANIPT and P_{double} may be expressed as P_{double}=0.151*ANIPT+0.0913. An example relationship between the observed collision rate (P_{c}) and P_{double} may be expressed as P_{double}=P_{c}.

For other implementations, a wireless device may select a random CW size between upper and lower exponential boundaries relative to a target CW size, and may determine a value for P_{double} based on a difference between the target CW size (CW_{target}) and each of the upper and lower exponential boundaries. In some aspects, the upper exponential boundary (Bᵤₚₚₑᵣ) and the lower exponential boundary (B_{lower}) may be expressed as:

Bᵤₚₚₑᵣ=2̂ceiling(log₂(CW_{target}))−1

B_{lower}=2̂floor(log₂(CW_{target}))−1

The probability (Pᵤₚₚₑᵣ) to select the upper exponential boundary and the probability (P_{lower}) to select the lower exponential boundary may be expressed as:

Pᵤₚₚₑᵣ=1−(CW_{target}−B_{lower})/(Bᵤₚₚₑᵣ−B_{lower})

P_{lower}=1−Pᵤₚₚₑᵣ

The value of CW_{target} may be determined by using one or more of the calibration graphs described above, for example, with respect to FIGS. 4, 7, and 10.

For other implementations, a wireless device may adjust the CW size to sweep through exponential values between CWₘᵢₙ and CWₘₐₓ based on the current and next average of the sweep, as follows:
if next average<CW_{target}
   double CW size up to CWₘₐₓ
else if current average<target CW<next average
   double CW size up to CWₘₐₓ with value of P_{double}
   P_{double}=(CW_{target}−current average)/(next average−current average)
else
   reset CW size to CWₘᵢₙ.
      The sweep averages for exponential sweeps are summarized below in Table 5, where the CW size and the sweep average are expressed as a number of backoff slot times:

TABLE 5

| | CW | | | | | | |
|---|---|---|---|---|---|---|---|
| | 15 | 31 | 63 | 127 | 255 | 511 | 1023 |
| Sweep average | 15.0 | 23.0 | 36.3 | 59.0 | 98.2 | 167.0 | 289.3 |

FIG. 12 shows an illustrative flowchart depicting an example operation 1200 for ensuring equal medium access between a first wireless device associated with an enhanced distributed channel access (EDCA) protocol and a number of second wireless devices associated with a load based equipment (LBE) protocol. As discussed above, the EDCA protocol may be defined by the IEEE 802.11e standard, and may prescribe doubling the contention window size for each subsequent medium access contention operation resulting from collisions on the wireless medium. The LBE protocol may be defined by a European Telecommunications Standards Institute (ETSI) Broadband Access Network (BRAN) for LBE standard, and may prescribe a fixed contention window size for all medium access contention operations regardless of collisions during medium access contention operations.

For the example of FIG. 12, the first wireless device may be EDCA device 200 of FIG. 2, and one or more of the second wireless devices may be LBE device 300 of FIG. 3. Thus, as described above, the first wireless device may be associated with a channel access mechanism that employs an exponential backoff procedure in the event of collisions, and the second wireless devices may be associated with a channel access mechanism that maintains a fixed contention window size for medium access contention operations regardless of collisions.

The first wireless device may determine a level of contention associated with gaining access to a wireless medium (1202). For some implementations, to determine the level of contention, the first wireless device may select a parameter indicative of a medium access success rate of the first wireless device (1202A), and may then determine a moving average of the selected parameter, the moving average indicative of the level of contention (1202B). The level of contention may indicate traffic levels on the wireless medium, congestion levels on the wireless medium, a likelihood of gaining medium access, and/or the number of devices contending for medium access. As discussed above, the selected parameter, which may indicate a medium access success rate, may be (i) the average number of interruptions per transmission, (ii) the average collision rate, or (iii) the average time between medium busy events.

The first wireless device may then select a contention window size based, at least in part, on the determined level of contention (1204). For some implementations, to select the contention window size, the first wireless device may retrieve, from a memory, a calibrated contention window size value corresponding to the determined moving average (1204A), and then define the selected contention window size based on the retrieved calibrated contention window size value (1204B). As discussed above, the memory may store, for each of a plurality of moving averages of the selected parameter, a corresponding calibrated contention size value that, when used to define the contention window size, results in similar medium access success rates for the first wireless device and the number of second wireless devices. In some aspects, the memory may store the calibrated CW size graph of FIG. 10.

Next, the first wireless device may select, for a medium access contention operation, a random backoff number from a range of numbers defined by the selected contention window size (1206). As discussed above, selecting the random backoff number from the range of numbers defined by the selected contention window size may ensure that LBE devices and EDCA devices have the same or similar medium access success rates.

Thereafter, the first wireless device may dynamically adjust the selected contention window size based on one or more conditions (1208). For example, after selecting the contention window size, the first wireless device may continue monitoring the wireless medium to detect changes in contention levels, and in response thereto may dynamically adjust the contention window size to ensure continued fairness between LBE devices and EDCA devices for medium access contention operations. Dynamically adjusting the selected contention window size is described in more detail below with respect to FIGS. 13A-13B.

The first wireless device may validate the selected contention window size (1210). For some implementations, the validation may be performed by determining a relationship between a parameter indicative of medium access success rates and various numbers of actively contending wireless devices, and then verifying that the selected contention window size results in equal medium access based on the relationship.

The first wireless device may also determine how many wireless devices are actively contending for medium access, for example, by determining an inverse of the relationship between the parameter and the various numbers of actively contending wireless devices and then estimating how many wireless devices are actively contending for medium access based on the inverse of the relationship (1212).

As mentioned above, the first wireless device may continue monitoring the wireless medium to detect changes in contention levels, and in response thereto may dynamically adjust the selected contention window size to ensure continued fairness between LBE devices and EDCA devices for medium access contention operations. For one example, FIG. 13A shows an illustrative flowchart depicting an example operation 1300 for dynamically adjusting the selected contention window size. The first wireless device may increase the selected contention window size based on an increasing number of wireless devices actively contending for medium access (1302), and may decrease the selected contention window size based on a decreasing number of wireless devices actively contending for medium access (1304).

For another example, FIG. 13B shows an illustrative flowchart depicting an example operation 1310 for dynamically adjusting the selected contention window size. The first wireless device may first determine a probability of collisions resulting from a plurality of the first wireless devices simultaneously contending for medium access (1312). Then, the first wireless device may double the contention window size based on the probability (1314), or may reset the contention window size to a minimum value based on the probability (1316).

The foregoing description discloses various methods and systems for determining a target contention window (CW) size for devices to share a wireless medium (such as a wireless channel). As previously described, a target contention window size may be determined using characteristics observed during operation (such as interruptions per transmission (IPT), average number of interruptions per transmission (ANIPT), average number of interruptions per successful TXOP (ANIPST), collision probability (CP), average collision probability (ACP), idle gap, and so on). Also as previously described, characteristics observed from the wireless network (such as IPT, ANIPT, ACP, idle gap, and so on) may be used by a wireless device to estimate the number of other wireless devices contending for a wireless channel.

If all wireless devices that may contend for the wireless medium implement the same methods in determining a target contention window size, then the contention window used by each wireless device may be approximately (or exactly) the same size (same number of slots). When all wireless devices use contention windows having approximately (or exactly) the same number of slots, and the wireless device selects a random backoff value from 0 to CW (where each slot has an equal chance of being selected), over a period of time, a wireless device's average backoff value is CW/2.

As previously described, conventional exponential backoff procedures (e.g., as defined in the IEEE 802.11e standards) automatically double the contention window size for a collision (2ⁿ−1, where n is related to the number of consecutive collisions). In an example where CWmin=15 and CWmax=63, the contention window may vary between 15, 31, and 63. Larger contention windows may increase delays in accessing the wireless medium, as larger backoffs may be randomly selected.

The below example illustrates how conventional exponential backoff procedures (such as doubling the contention window size and randomly selecting a backoff value) may increase delays in accessing the wireless medium. Continuing with the example where CWmin=15 and CWmax=63, there exist ten wireless devices (i) initialized in sequence and in one second intervals, (ii) having queued frames in the Best Effort (BE) access category (AC), and (iii) contending for access to the wireless medium.

FIG. 14 shows a graph 1400 illustrating the access delay (in ms) for the first initialized wireless device during simulation over one minute of contending for medium access. The access delays (access latency) illustrated are the time period from beginning backoff using the random backoff value to the moment a successful transmission occurs. During the simulation, the access delay for the wireless device reaches 360 ms and surpasses 300 ms multiple times.

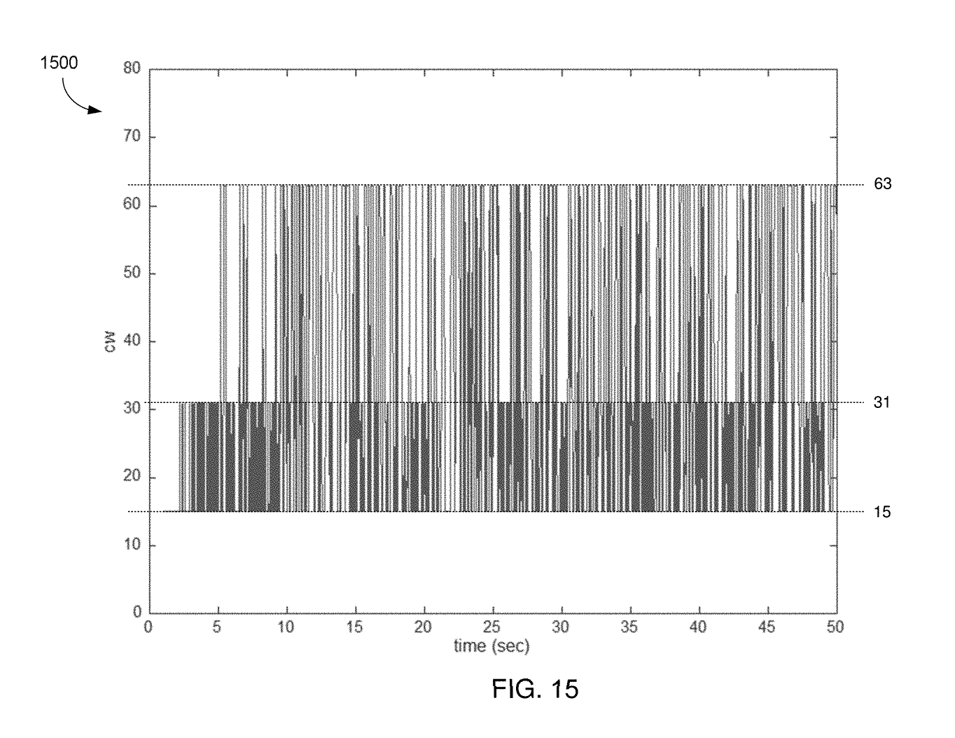

FIG. 15 shows a graph 1500 illustrating the change in contention window size for the first initialized wireless device during the same simulation. As shown, the contention window size repeatedly varies between 15, 31, and 63 time slots, indicating that a significant number of collisions occurred to cause an exponential increase in contention window size.

The following describes example embodiments for decreasing access delay due to exponential backoffs after collisions and ensuring fair access to the wireless medium for contending wireless devices. Each wireless device may moderate the contention window size based on an observed variable (such as ANIPT), which causes the contention window (CW) sizes to be approximately the same at all local wireless devices using, e.g., clear channel assessment (CCA) mechanisms. Additionally, if all wireless devices use approximately the same contention window size, a wireless device may determine a non-random backoff value if the previously selected random backoff value did not cause a collision after backoff. The non-random backoff value may be equal to CW/2, which is the average value for random backoffs between 0 and contention window (the contention window size). The below examples are provided as describing transmitting Best Effort access category traffic at an access point for ease of explanation, but the application covers all embodiments of transmitting other access category traffic and by other wireless devices.

If all wireless devices (such as the ten wireless devices in the previous example) use contention window moderation, and as a result use approximately the same contention window size to select non-random backoff values, then the wireless devices may access the wireless medium in sequence without collision. In the example, each device's backoff counter (counting down from the selected backoff value) will not equal another device's counter. Therefore, each device will access the wireless medium at a different time.

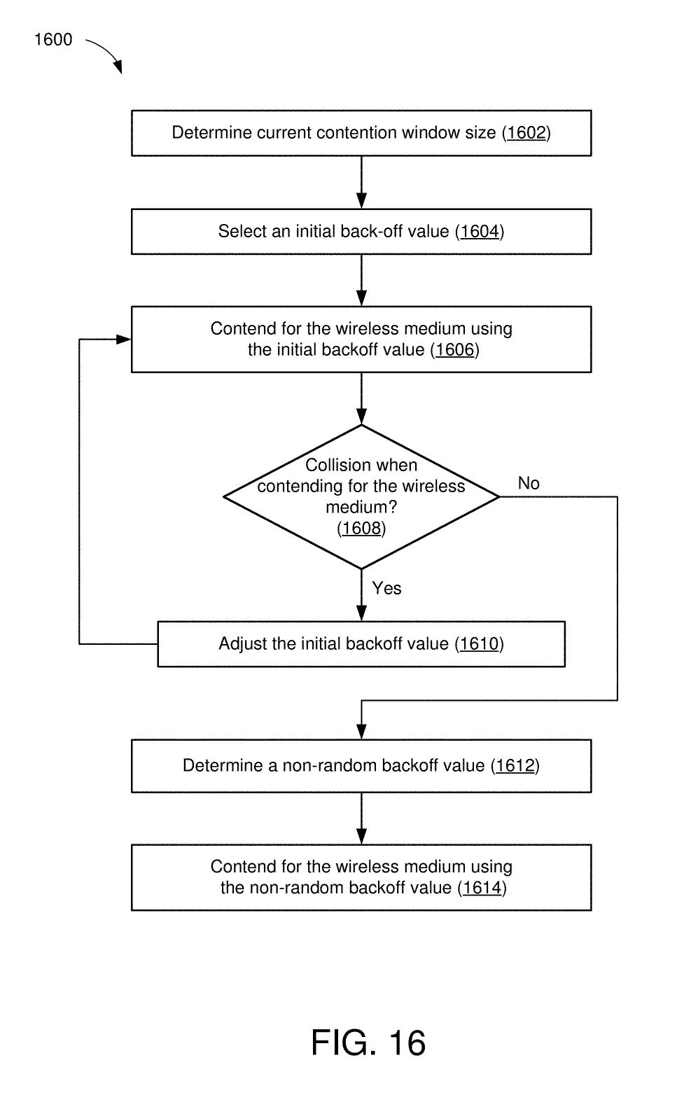

FIG. 16 shows an illustrative flowchart depicting an example operation 1600 for a wireless device to determine a non-random backoff value when all wireless devices use the same contention window size. Beginning at 1602, the wireless device determines a target contention window size based on a characteristic of the wireless medium. The wireless device may determine the contention window size using any of the previously described methods.

For example, the wireless device may use IPT or ANIPT to determine the target contention window size, which may increase by uniform increments (such as 2 slots) for each additional wireless device contending for the wireless medium. One function of the target contention window size is provided in EQ. 8 below:

Target CW=14+2*ANIPT (EQ. 8)

where ANIPT may approximately relate to the estimated number of devices, other than the wireless device, contending for the wireless medium. The ANIPT may be maintained as a moving average of the number of interruptions per transmission (IPT) as shown in EQ. 8a below:

ANIPT=previous ANIPT+0.6*(IPT−previous ANIPT) (EQ. 8a)

where previous ANIPT is the ANIPT value to be updated based on the IPT, the IPT is counted during the backoff corresponding with each transmission, and 0.6 is a damping factor. With the Target CW determined according to EQ. 8, the contention window (contention window size) may be determined based on the Target contention window, such as according to EQ. 8b below:

CW=previous CW+0.6*(Target CW−previous CW) (EQ. 8b)

where previous CW is the CW to be updated based on the Target CW. ANIPT, Target CW and CW are updated each time a new IPT is available (such as each time the backoff expires). While EQ. 8a and EQ. 8b include a damping factor equal to 0.6, other suitable damping factors may be used, including 0.

Many wireless devices that use exponential backoff have a CWmin=15 for Best Effort access category traffic. Setting an effective CWmin=14 (as seen in EQ. 8 for ANIPT=0) allows the wireless device to be relatively backwards compatible with legacy devices, and 14 is wholly divisible by 2 (no remainder), which no remainder may be helpful in some example embodiments. However, the effective CWmin may be values other than 14, for example Target CW=10+2*ANIPT or Target CW=20+2*ANIPT. The ANIPT multiplier may also vary (such as Target CW=10+4*ANIPT, Target CW size=20+4*ANIPT, Target CW size=20+6*ANIPT, and so on). Different parameter values may result in different levels of backwards compatibility with devices employing exponential backoff.

Using EQ. 8, the target contention window size is 14 when the wireless device is the only one contending for the wireless medium (ANIPT=0). If the wireless device is the only one contending for the wireless medium, then there are no interruptions when counting down from its selected backoff value during the wireless device's backoff. Thus, the wireless device observes zero or almost zero IPT or ANIPT.

For greenfield spectrums or situations or other situations where backwards compatibility is not a concern or issue, a larger effective CWmin than expressed in EQ. 8 (such as greater than 14) may be used. For example, Wi-Fi devices in the 6 GHz frequency band may use a larger effective CWmin than if operating in the 2.4 GHz frequency band or the 5 GHz frequency band. One example function of the target contention window size is provided in EQ. 8c below:

Target CW=40+2*ANIPT (EQ. 8c)

As shown, the target contention window size is 40 instead of 14 (for EQ. 8) when the wireless device is the only one contending for the wireless medium (ANIPT=0). Another example function of the target contention window size is provided in EQ. 8d below:

Target CW=100+2*ANIPT (EQ. 8d)

As shown, the target contention window size is 100 instead of 14 (for EQ. 8) or 40 (for EQ. 8c) when the wireless device is the only one contending for the wireless medium (ANIPT=0). While examples of the effective CWmin are shown to be 40 or 100, any suitable effective CWmin may be used, and the disclosure should not be limited to the provided examples.

Referring back to EQ. 8 in providing illustrative examples of some ways to determine the contention window size using ANIPT, Table 9 illustrates example ANIPT values as related to the number of other devices contending for the wireless medium (No. of other WDs) and the target contention window size calculated using EQ. 8.

TABLE 9

| No. of other WDs | ANIPT | Target CW |
|---|---|---|
| 1 | 1 | 16 |
| 2 | 2 | 18 |
| 3 | 3 | 20 |
| 4 | 4 | 22 |
| 8 | 8 | 30 |
| 13 | 13 | 40 |
| 18 | 18 | 50 |

Since ANIPT may be a non-integer value, the target contention window size may be calculated to be a non-integer value. Therefore, 14+2*ANIPT may be rounded to a whole number (such as rounded up, rounded down, or rounded off).

Referring back to FIG. 16, once the wireless device determines the current contention window size in 1602 (such as based on EQ. 8, EQ. 8a, and EQ. 8b), the wireless device selects an initial (first) backoff value (1604). In some example embodiments, the wireless device randomly selects a backoff value from the range 0 and the target contention window size, wherein the probability for selecting any slot is uniformly distributed. In other example embodiments, the initial backoff value may be selected by any means (including random or non-random selection from a subrange of the contention window slots).

For example, the wireless device may initialize the ANIPT at 0, initialize the CW at 14, and initialize the backoff counter at any value (such as 0 or a randomly selected value from the range [0,CW]). In another example embodiment, the initial values of ANIPT and CW may be based on a previous traffic burst that arrived at the wireless device. An initializing wireless device may set the backoff counter to an initial (first) backoff value of 0 because, for example, collisions may cause the wireless device to adjust the initial backoff value (such as through randomization) to avoid causing further collisions (as described below). Additionally, multiple devices typically do not initialize at exactly the same time to cause collisions if initializing the backoff counter to 0.

Once the wireless device has selected the initial backoff value (1604), the wireless device contends for the wireless medium using its initial backoff value (1606). For example, if the initial backoff value is 11, the wireless device's backoff counter is set to 11 and counts down during the backoff period. Once the counter reaches 0, the wireless device transmits on the wireless medium.

Once the wireless device transmits on the wireless medium (1606), the wireless device determines if there is a collision (1608). In some example embodiments, the wireless device determines a collision exists by not receiving an acknowledgement (ACK) after transmission from an intended recipient. If a collision is detected, then the wireless device may adjust the initial backoff value (1610) and contend for the wireless medium using the adjusted initial backoff value (reverting to 1606 in FIG. 16). Adjusting the initial backoff value may involve including randomness to the backoff value (as described below). If a collision is not detected (such as the wireless device receiving an ACK from the intended receiving device), then the wireless device may set a non-random backoff value (1612) and use the non-random backoff value to contend for the wireless medium for future transmissions (1614). The non-random backoff value may be equal to CW/2.

Referring back to 1610, the wireless device may select a new backoff value as it did in selecting the initial backoff value. For example, if the wireless device randomly selected the initial backoff value to be a value in the range of [0,CW] in 1604, then the wireless device may again randomly select the backoff value to be a value in the range of [0,CW] in 1610. However, the wireless device may adjust the initial backoff value, whether randomly or non-randomly selected, by any means (such as by selecting a backoff value from [0,a], when a is less than contention window, decrementing or incrementing the initial backoff value from 1604, using a different probability distribution for the slots when randomly selecting the backoff value, randomly selecting a backoff value from the range of [CW/2−b, CW/2+b] where b<CW/2, randomly selecting a backoff value from the set of ranges {[CW/2−b, CW/2−1], [CW/2+1, CW/2+b] } where b is less the CW/2 (thus the set is equivalent to [CW/2−b, CW/2+b] with CW/2 omitted), and so on). The wireless device then uses the backoff value determined in 1610 to contend for the wireless medium (reverting to 1606).

Referring to 1612, the wireless device may determine a non-random backoff value to be used for future contentions for the wireless medium. If all wireless devices select the same non-random backoff value after a successful transmission (and the non-random backoff value is the same or relatively the same at each of the wireless devices), then the wireless devices create an order in which they will access the wireless medium without further collisions.

In a simplified example, there exist two wireless devices contending for the wireless medium. The first wireless device's initial backoff value is 1, the second wireless device's backoff value is 2. Both wireless devices will set their non-random backoff value equal to 2 in 1612. The first wireless device successfully transmits during the second wireless device's backoff, and the first wireless device sets its backoff counter to 2 (with the second wireless device's backoff counter currently at 1). The second wireless device then successfully transmits, and the second wireless device sets its backoff counter to 2 (with the first wireless device's backoff counter, previously set to 2, now at 1). Therefore, the two wireless devices may alternate transmissions without causing collisions. Using a non-random backoff value to create a recurring sequence of the wireless devices accessing the wireless medium may be referred to as a distributed round robin (DRR) scheduler. A wireless device accessing the medium in a distributed round robin fashion (such as using a non-random and adaptable backoff) may be referred to as a DRR device.

A plurality of wireless devices using non-random backoff values (assuming the non-random backoff value is greater than or equal to the number of wireless devices) may therefore organize themselves so that they access the wireless medium in a round-robin fashion. As a result, each wireless device may have a chance to access the wireless medium once before another wireless device again accesses the wireless medium (which creates fair access to the wireless medium). In 1612, the wireless device may select any non-random backoff value if (i) the non-random backoff value is greater than or equal to the number of contending devices and (ii) the contending devices select the same or approximately the same non-random backoff value.

In some example embodiments, the wireless device may determine its non-random backoff value to be CW/2. If the target contention window size corresponds to EQ. 8, Table 10 illustrates example non-random backoff values=CW/2 in relation to the number of other devices contending for the wireless medium (No. of other WDs).

TABLE 10

| No. of other WDs | CW Size | Non-random backoff value |
|---|---|---|
| 1 | 14 | 7 |
| 2 | 16 | 8 |
| 3 | 20 | 10 |
| 4 | 22 | 11 |
| 8 | 30 | 15 |
| 13 | 40 | 20 |
| 18 | 50 | 25 |

If the contention window size is an odd number, CW/2 is not a whole number. As a result, in some example implementations, the wireless device may round CW/2 to a whole number (such as rounding up, rounding down, or rounding off). Therefore, the wireless device may adjust the value when selecting the non-random backoff value as necessary.

After determining the non-random backoff value (1612), the wireless device contends for the wireless medium using the non-random backoff value. Once all wireless devices select the same non-random backoff value in 1612 (such as CW/2, wherein the (target) contention window size is the same for all wireless devices), the wireless devices access the wireless medium, without collision, in a round-robin fashion.

The number of wireless devices contending for the wireless medium may decrease over time, and the contention window size used by the still present wireless devices may be larger than the target CW size of EQ. 8. As a result, in some example embodiments, the wireless devices may periodically redetermine the target contention window size and reduce the contention window size to account for a reduction in contending devices. In some example embodiments, the contention window sizes may not change at all wireless devices at the same instant. As a result, changing the contention window size at one or more devices may imply that the ordering of the wireless devices accessing the wireless medium may change. For example, collisions may be caused by devices that previously occupied non-colliding positions in the round robin order but have since adjusted their contention windows. Such collisions may reduce over time as the wireless device's backoff is adjusted, and through other measures such as adding randomness to the initial backoff after one or more consecutive collisions. The wireless devices may also update the non-random backoff value if reducing the contention window size. In some example embodiments, the initial backoff and adding randomness to the backoff may differ depending on whether the device just initiated transmission or the wireless device recently modified its contention window.

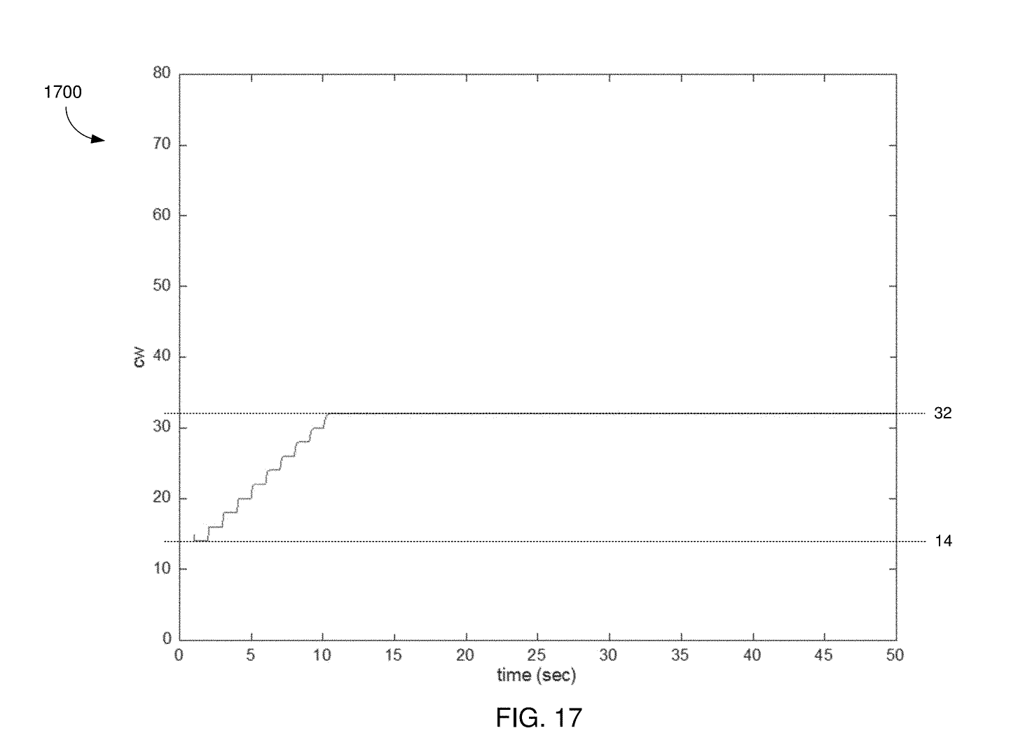

Referring back to the prior example of 10 wireless devices (i) initialized in sequence and in one second intervals, (ii) having queued frames in the Best Effort (BE) access category (AC), and (iii) contending for access to the wireless medium, FIG. 17 shows a graph 1700 illustrating the change in contention window size for the first initialized wireless device when the 10 wireless devices determine a contention window size as indicated by EQ. 8, EQ. 8a, and EQ. 8b (wherein the contention window size increases by 2 slots for each additional device contending for the wireless medium using the distributed round robin scheduler). The graph 1700 approximately illustrates a step function, where the contention window size increases by two slots each second a wireless device is initialized. When the first wireless device is initialized, the contention window size is 14 slots. The contention window size then increases by two slots the next second (when the second wireless device is initialized), by another two slots the next second (when the third wireless device is initialized), and so on until the contention window size reaches 32 slots (when the last wireless device is initialized). As compared to graph 1500 in FIG. 15, the contention window size does not vary once the number of devices contending for the wireless medium is constant.

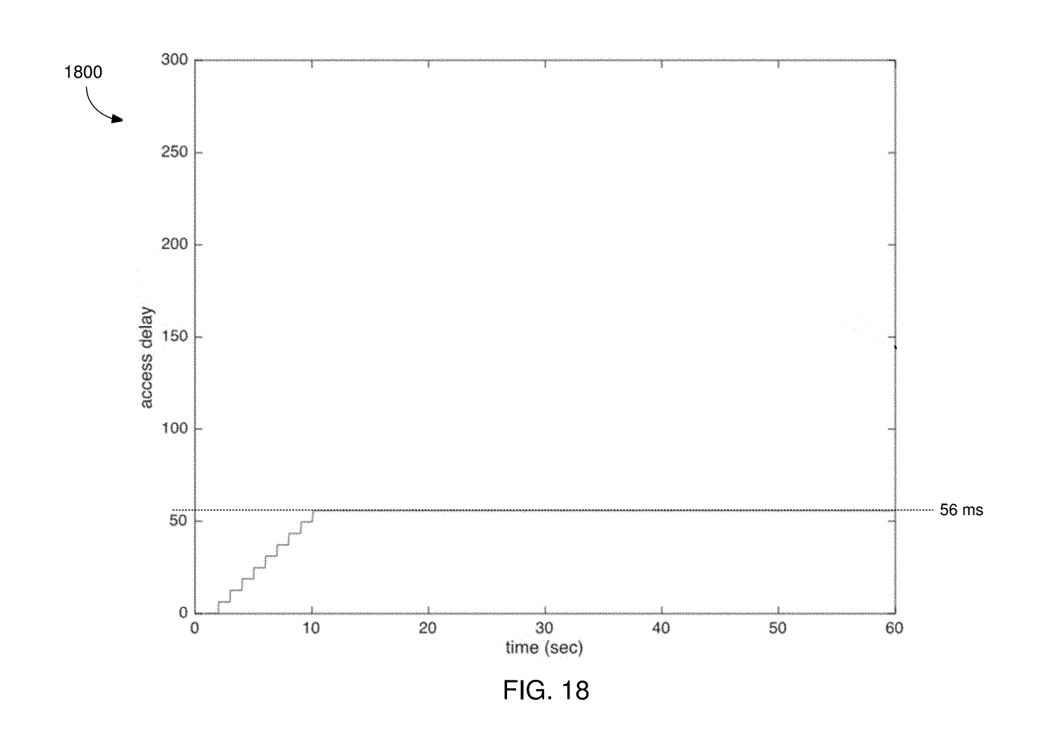

With a stable contention window size and non-random backoff, as compared to the contention window when using exponential backoff, the delay in accessing the wireless medium is also more stable. FIG. 18 shows a graph 1800 illustrating the simulated access delay (in ms) for the first initialized wireless device for the example of FIG. 17 (where the 10 wireless devices have data queued for transmission). In the simulation for the example for FIG. 14 (where the wireless devices use exponential backoff), the access delay for the first wireless device exceeds 300 ms multiple times. However, as shown in graph 1800 (FIG. 18), when exponential backoff is replaced with the stable contention window size and non-random backoff, the simulated access delay for the first wireless device stabilizes at approximately 56 ms when the contention window size reaches 32 slots and 10 wireless devices participate in the round robin schedule (as shown in graph 1700 in FIG. 17).

If a new wireless device (or a wireless device that does not use a non-random backoff value) contends for the wireless medium (when the other wireless devices access the wireless medium in a distributed round-robin fashion), collisions may occur between the new device and the other wireless devices. Therefore, the wireless devices using a non-random backoff value that notice a collision (such as the new device transmitting during the same slot and corrupting the wireless device's own transmission), may maintain their non-random backoff for sporadic and non-repeating collisions. When the new wireless device finds and uses an empty slot in the sequence, the other wireless devices may adjust their target contention window size or backoff value (such as changing the slot or altering the non-random backoff value) in order to accommodate the new device and include enough slots in the contention window to allow other new wireless devices to enter into the sequence.

If IPT or ANIPT is used to determine the target contention window size, the wireless devices may determine to increase the contention window size. For example, if a device assumes only one device is attempting to access the wireless medium (because its ANIPT is 0) and sets its target contention window size to 14, selects an initial backoff, and successfully transmits, the device may set its non-random backoff value as 7. When a new device accesses the wireless medium during an idle slot of the contention window, the existing device's ANIPT will increase to 1. As a result, the existing device will increase its contention window to 16 and therefore increase its non-random backoff to 8. As such, a round robin order may be maintained as new devices find empty slots to transmit and the contention window changes as a function of the number of wireless devices accessing the wireless medium.

There may exist instances when two DRR devices conflict with each other (selecting the same slot for transmission). In some example embodiments, a DRR device counts the number of consecutive collisions after a successful transmission to determine if a threshold n consecutive collisions occur. If less than n consecutive collisions are counted, it may be assumed that the DRR device is experiencing temporary interference not the result of a conflicting DRR device. Hence, if the DRR device experiences less than n consecutive collisions between successful transmissions, the DRR device may continue to access the medium using the non-random backoff (such as CW/2).

However, if the consecutive collision count reaches n consecutive collisions, it may be assumed that two DRR devices are in conflict (both devices using the same non-random backoff and their backoff counters having the same count at the same time). As a result, once a DRR device experiences n consecutive collisions, the DRR device may backoff using a random backoff value in a range around the non-random backoff value before attempting to access the wireless medium. One example range is [CW/2−1, CW/2+1]. However, other example ranges may be any size around the non-random backoff value. In some example embodiments, the range increases in size depending on the number of consecutive collisions that occur after initially including a range to adjust the wireless device's backoff. The range size may increase uniformly, linearly, or exponentially. In one example, if a wireless device uses a range [CW/2−1, CW/2+1] (3 slots) and again experiences a collision, the wireless device may use a range [CW/2−2, CW/2+2] (5 slots), and so on, increasing the range size by a uniform amount each collision. In another example, a wireless device may use a range size of 3 slots on the first attempt, 15 slots on the second attempt, 63 slots on the third attempt, and 255 slots on the fourth attempt (range size of 2ⁿ−1 for n attempts), increasing the range size by an exponential amount each collision. In other examples, the wireless device may increase the range size in other ways or use the same range multiple times in selecting a backoff value before increasing the size. For example, the wireless device may use the same range size for the first retry before increasing the range size.

In further example embodiments, a DRR device may select a random backoff in the range [0, CW/2−1] when the DRR device reaches n (thus experiencing n or more) consecutive collisions. In other example embodiments, a DRR device may observe a set of available slots after which no interruption occurs. In other words, at least one idle slot occurs after an available slot. Thus, when the DRR device experiences n or more consecutive collisions, the DRR device may randomly pick a backoff from the set of available slots. In some example embodiments, the DRR device may ignore or otherwise not use the number of interruptions occurring during a random backoff (or a backoff unequal to CW/2 or CW/2−1) to determine the contention window size.

A system where DRR devices experiencing less than n consecutive collisions continue to use a non-random backoff allows the DRR devices to independently reach a recurring sequence for the wireless devices to access the wireless medium without collision. n may be any integer value (such as 1, 2, and so on). In some example embodiments, n is preset to a fixed integer value. In some other example embodiments, n may vary depending on the non-random backoff value, contention window size, number of devices accessing the wireless medium, or other characteristics of the wireless medium or wireless device.

In some example embodiments, n may change depending on the number of consecutive successful attempts in accessing the wireless medium. For example, after using a range around the non-random backoff value to adjust a wireless device's backoff, the wireless device may increase n as more consecutive attempts to access the wireless medium are successful.

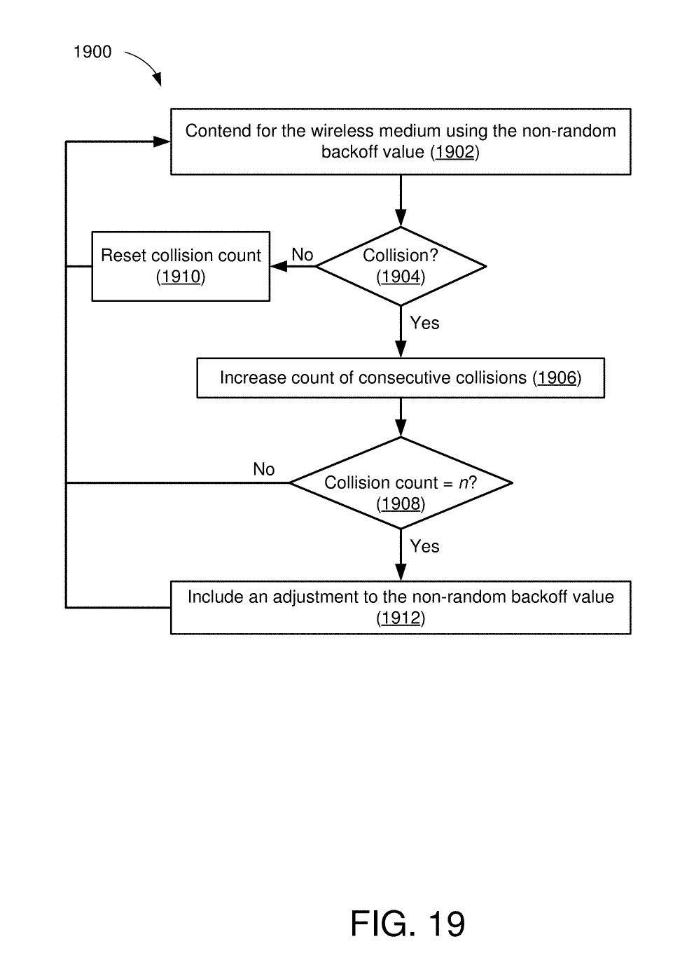

As previously described, DRR devices may conflict, and a slot used by a wireless device having a non-random backoff may become occupied or otherwise unavailable, causing repeated collisions. FIG. 19 shows an illustrative flowchart depicting an example operation 1900 for a wireless device to determine a new slot of the contention window when detecting collisions. Beginning at 1902, the wireless device contends for the wireless medium using its non-random backoff value (e.g., 1614 of FIG. 16). If the wireless device does not detect a collision (1904), then the wireless device continues to use the non-random backoff value to contend for the wireless medium (reverting to 1902).

As previously described, the wireless device may use a threshold (n) in case the collision(s) are temporary. For example, if the wireless medium is occupied one time when the wireless device attempts to transmit, but is otherwise available during the slots corresponding to the wireless device's non-random backoff value, the wireless device might not change its slot in order to prevent causing unnecessary collisions with other wireless devices. However, if the wireless device observes an n number of consecutive collisions (such as n consecutive transmissions or re-transmissions without receiving an ACK), the wireless device may assume the slot corresponding to the non-random backoff value is occupied or otherwise unavailable.

If the wireless device observes a collision (1904), the wireless device may increment its running count of consecutive collisions in 1906 (such as from 0 to 1 for the first observed collision, 1 to 2 for an observed collision consecutive to the first collision, and so on). If the updated collision count does not equal a threshold number n (n consecutive collisions) in 1908, then the wireless device may continue to use the non-random backoff value to contend for the wireless medium (reverting to 1902). If the wireless device previously observes one or more collisions (the running collision count is greater than 0 but less than n) but successfully transmits on the wireless medium the next time (no collision in 1904), the wireless device may reset the collision count (1910) and continue using the non-random backoff value to contend for the wireless medium (reverting to 1902). Hence, the interference may be assumed to be temporary.

Referring back to 1908, if the wireless device observes n consecutive collisions, the wireless device may include an adjustment to the non-random backoff value (1912). Therefore, the wireless device's backoff counter may be increased or decreased so that a slot different than the one corresponding to the non-random backoff value is used by the wireless device. The process reverts to 1902, where the wireless device determines if the new slot is available. If the wireless device does not observe a collision (1904) for its transmission during the new slot, the wireless device may use the non-random backoff value (without adjustment, such as CW/2) for successive backoffs.

If the wireless device continues to observe collisions after adjustment, the wireless device may repeat process 1900 to find another different slot. In some example embodiments, the wireless device may decrease the number of consecutive collisions to observe (less than n) before again adjusting the backoff value.

While the operation 1900 describes using the number of consecutive collisions to determine when to adjust the slot, different observations may be used. For example, the wireless device may determine an average number of collisions or frequency of collisions and compare those values to a threshold.

Referring back to 1912, and as previously described, the adjustment may be selecting a random value from the range [CW/2−1, CW/2+1]. Thus, the wireless device may set its backoff counter using an adjusted value, the adjusted value illustrated in EQ. 9 below:

Adjusted value=Non-random backoff value+r, where −2<r<2 (EQ. 9)

In some example embodiments, r does not equal 0 so that there is a difference between the adjusted value and the non-random backoff value. In other example embodiments, the absolute value of r may be bounded by more than 2 and less than half the contention window size (such as one quarter of the contention window size, another percentage, a constant, and so on). Thus, the range of r may be the amount of randomness allowed for the wireless device to adjust the backoff.

The example random selection of r may be a uniform distribution, or alternatively, a different distribution (such as a normal distribution, bimodal distribution, and so on). In other example embodiments, the adjustment r may be fixed (such as r=1 or a different constant). Additionally, the bounds of r may change depending on the number of collisions after adjusting the backoff. For example, as previously described, the range may increase as more consecutive collisions are observed so that the amount of randomness increases.

A wireless device using a non-random backoff value may sometimes have no data queued for transmission, and thus the wireless device does not attempt to transmit on the wireless medium (the wireless device is idle). Therefore, another device might begin using the slots the idle device would typically use without creating a collision. In some example embodiments, an idle device may still track the contention window, so that it stays in tune with the activity on the wireless channel. For example, the wireless device may continue to “backoff” using its backoff counter and the non-random backoff value (such as CW/2) while the wireless device is idle. The wireless device may then observe if the wireless medium becomes occupied (such as through carrier sense) during the slots the wireless device would have used. Backoffs by the wireless device when idle may be referred to as idle run backoffs. In further example embodiments, the wireless device may sense the wireless medium during other slots of the idle run backoff, determining which slots the wireless medium is unoccupied.

In some example embodiments where the non-random backoff value for wireless devices that are not idle is a fixed value (such as CW/2), a wireless device performing an idle run backoff may use a non-random backoff value equal to the fixed value minus 1 (such as CW/2−1). Subtracting one from the non-random backoff value for the idle wireless device may account for the difference in the number of interruptions observed by the idle wireless device during an idle run backoff and the number of interruptions observed by other non-idle wireless devices during their backoffs. A non-idle wireless device does not observe an interruption from the idle wireless device because the idle wireless device is not attempting to transmit. However, the idle wireless device observes an interruption from the non-idle wireless device (the non-idle wireless device transmits after its backoff). Therefore, the number of interruptions observed by the idle wireless device during an idle run backoff may be one more than the number of interruptions observed by non-idle wireless devices. As a result, subtracting one from the non-random backoff value for the idle wireless device compensates for the difference in observed interruptions so that the idle run backoff at the idle wireless device and the backoffs at non-idle wireless devices are the same number of slots.

If the wireless device senses that the wireless medium is unoccupied after each idle run backoff, the wireless device may keep the same non-random backoff (or at least a non-random backoff based on CW/2) and initiate transmissions in the same slot as if it had not stopped contending for the wireless medium. For example, if the non-random backoff value is CW/2, and the wireless device would have transmitted in a current slot if data was queued to transmit, the wireless device may transmit in the next CW/2 slot.

However, if the wireless device senses that the slot it normally uses has become occupied (such as over a number of consecutive idle run backoffs), then the wireless device may determine to initiate transmissions during a different slot. If the other devices contending for the wireless medium use the same non-random backoff value (such as CW/2) for backoff, then the unoccupied slots (idle gaps) may repeat at the slot frequency equal to the non-random backoff value.

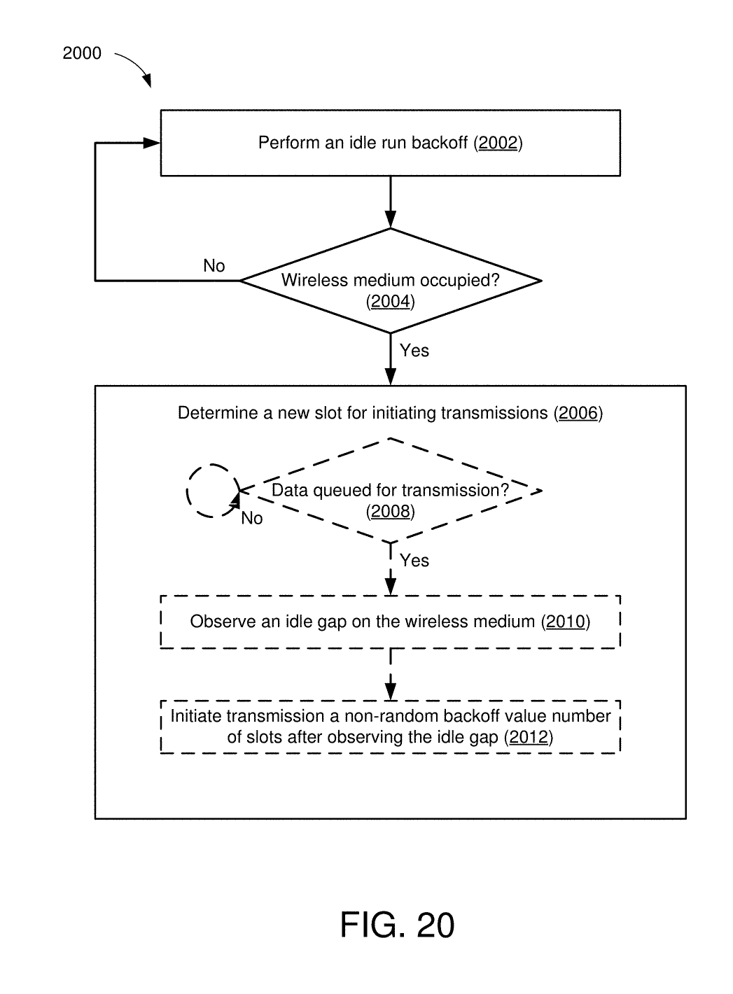

FIG. 20 shows an illustrative flowchart depicting an example operation 2000 for an idle wireless device to determine when to initiate transmissions. Beginning at 2002, the wireless device performs an idle run backoff. After the idle run backoff, if the wireless device senses that the wireless medium is available (the slot the wireless device would normally use to transmit is not occupied) in 2004, the wireless device may continue to use the same slot when initiating transmission. The wireless device may continue to perform idle run backoffs (reverting to 2002) and observe the wireless medium (2004). Some wireless devices may include an AIFS duration in delaying its backoff during each backoff period (such as LBE devices to assist in creating fair access to the wireless medium with EDCA devices, as described for 908 of FIG. 9, and so on). However, applying an AIFS delay for an idle run backoff that finishes between two transmissions may cause the backoff slots to become misaligned, as the wireless device's idle run backoff may be longer than the wireless device's actual backoff when accessing the wireless medium. Therefore, if the wireless device applies a delay of an AIFS duration to its backoff, the wireless device may perform idle run backoffs without applying such delay (immediately beginning the next idle run backoff slot countdown).

Referring back to 2004, if the wireless device senses that the wireless medium is occupied, the wireless device may determine a new slot for initiating its next transmission (2006). In some example embodiments, the wireless device may wait a plurality of consecutive idle run backoffs sensing that the wireless medium is occupied before determining a new slot for initiating its next transmission.

One example process for determining a new slot is illustrated in 2008, 2010 and 2012. In 2008, the wireless device remains idle until data is queued for transmission. With data queued for transmission, the wireless device is to contend for the wireless medium. In some example embodiments, the wireless device observes the wireless medium to identify an idle gap (a time when the wireless medium is unoccupied) before an interruption. In some example embodiments, the idle gap may be observed by the wireless device during an idle run backoff. In other example embodiments, the wireless device may observe or identify a set of available slots after which no interruption occurs (or otherwise maintain information about such set of slots previously identified). If the wireless device's non-random backoff is determined to end during another transmission (thus sensing that the wireless medium is occupied), the wireless device may select one of the available slots in the set to create a backoff (thus shifting its backoff to occupy one of the available slots in the set).

As previously described, idle gaps may repeat every non-random backoff number of slots if the other contending devices use the same non-random backoff value for their backoffs. For example, if the non-random backoff value is CW/2, then an observed idle gap should repeat every CW/2 slots. As a result, after the wireless device observes an idle gap during a time slot, the wireless device may initiate its transmission a non-random backoff value number of slots after the idle gap in 2012 (such as CW/2 number of slots after the idle gap).

In some example embodiments, the wireless device may observe an interruption, where an idle gap exists before the interruption. Therefore, the wireless device may initiate its transmission a non-random backoff value−1 number of slots after the interruption to align with the recurring idle gap preceding the interruption. When the wireless device successfully transmits using the new slot, the wireless device may use its non-random backoff value for successive backoffs.

In other example embodiments alternative to the wireless device no transmitting when being idle, a wireless device may send an abbreviated transmission (a transmission shorter than typical for transmitting data) to keep the wireless medium occupied during its slots while reducing the amount of time the wireless medium would be occupied. For example, a wireless device may transmit a clear-to-send (CTS) when the wireless device is not sending data.

In some embodiments, a timeout may occur when the device may cease sending the abbreviated transmission after the device has been idle for a predetermined amount of time. Use of the timeout may set an upper threshold for the amount of time between traffic being queued for the device to transmit, during which time the device may send the abbreviated transmission (and therefore not give up its slot in the sequence for contending for the wireless medium). If the time gap between traffic being queued for transmission exceeds the threshold, the device may give up its slot in the sequence for contending for the wireless medium by ceasing transmission during its slot. In this manner, other devices may determine that the slot is idle, and update their sequences for contending for the wireless medium.

For example, the device may use a timer to determine if the device has been idle (or has not transmitted traffic other than an abbreviated transmission or other transmission only to preserve the device's slot in the sequence) for a predetermined amount of time (such as 0.5 seconds, or another suitable amount of time). If the timer has not yet reached the predetermined amount of time, the device continues to send the abbreviated transmission while idle. Once the timer reaches the predetermined amount of time, the timeout occurs, for which the device determines that it has been idle for the predetermined amount of time, and the device stops sending the abbreviated transmission. If during the predetermined amount of time the device receives traffic to be transmitted (such as queued traffic for transmission), the timer resets for the next occurrence when the device is idle.

In some wireless environments, devices may have different levels of priorities for accessing the wireless medium. For example, transmitting Best Effort traffic may have a higher priority than transmitting Background traffic. In another example, a station (STA) contending for the wireless medium may have a lower priority for transmitting data than an access point (AP) contending for the wireless medium.

As a result, to reduce the amount of time a lower priority device occupies the wireless medium, the lower priority device may transmit data during only a portion of its transmit opportunities under the described round robin schemes. For example, if a station and an access point are contending for the wireless medium, and the station has a lower priority than the access point, the station may transmit data 2 times and transmit a CTS 3 times for every 5 transmit opportunities, while the access point transmits data every transmit opportunity. While the portion 2/5 is described in the example, any portion may be used. In some example embodiments, the portion of opportunities during which to send traffic may depend on the level of priority (such as wireless devices with higher levels of priority using larger portions of their opportunities to transmit data than wireless devices with lower levels of priority). Additionally, the level of priority may depend on, e.g., the type of wireless device (such as if an access point, station, soft AP, and so on) and/or the access category of data to be transmitted.

In some example embodiments of a wireless device transmitting only during a portion of its transmit opportunities (such as using a fraction or ratio of when transmitting during transmit opportunities to all transmit opportunities for a wireless device), a wireless device may backoff (as previously described), but then forego transmitting during its transmit opportunity after backoff. For example, if a wireless device transmits every other transmit opportunity (and foregoing transmitting the other intermediate transmit opportunities), the transmit ratio (or fraction) is ½ to represent one transmission per every two transmit opportunities. In another example, if a wireless device transmits 3 out of every 5 transmit opportunities (foregoing transmitting the other 2 transmit opportunities), the transmit ratio is 3/5 to represent 3 transmissions per every 5 transmit opportunities.

Similar to when a wireless device has no information to transmit but still performs backoff, a performed backoff for which the transmit opportunity is foregone by the wireless device may be called an idle run backoff. As previously described, if a wireless device performs an idle run backoff, the wireless device may begin the next backoff without waiting an Arbitration Interframe Space (AIFS) duration (such as for an EDCA device). In other example embodiments, the backoff counter may be decremented by one before a backoff following an idle run backoff so as to reduce the number of slots waited during backoff. Waiting the AIFS duration after an idle run backoff may cause a misalignment between the wireless device and other devices backing off in the distributed round robin scheme. As previously stated, the AIFS duration is AIFS=AIFSN[AC]*ST+SIFS. SIFS that is included in the AIFS may have a duration that is not an integer number of slot durations. For example, a SIFS may have a duration of 16 μs, while a slot may have a duration of 9 μs. Therefore, the SIFS duration may cause the misalignment. Additionally or alternatively, waiting the full number of slots after an idle run backoff may cause a misalignment between the wireless device and other devices backing off in the distributed round robin scheme because the other devices observe no interruption from the wireless device. When no interruption is observed during the slot (such as when the wireless device foregoes its transmit opportunity during such slot), the other devices count down the slot as part of their backoff. Hence, the other devices may wait one slot less as a result of counting down for the slot typically used by the wireless device. As a result, the wireless device may be configured to wait one slot less during backoff to prevent misalignment. For example, if the non-random backoff value is CW/2, then the wireless device may wait CW/2−1 slots rather than CW/2 slots during backoff.

For example, there may exist 5 devices transmitting using the distributed round robin scheme. In the example, a first wireless device may have a transmit ratio of 1/2, and the other 4 devices may transmit during every one of their respective transmit opportunities. Therefore, for a first cycle of backoffs, all 5 devices transmit after their respective backoff. For a second cycle of backoffs, the first wireless device does not transmit during its transmit opportunity (but the other devices transmit during their respective transmit opportunities).

In the example, the first wireless device determines the interruptions per transmission (IPT) to be 4 during every backoff, because the other 4 devices in the distributed round robin scheme always transmit during their respective transmit opportunities. If EQ. 8 μs used to determine the target contention window size and ANIPT=IPT=4 for the first wireless device (since the interruptions per transmission is static), the first wireless device calculates the contention window size to be 14+2*4=22 slots. If the non-random backoff value is CW/2, then the first wireless device would transmit every 11 slots if the transmit ratio is 1. However, since the first wireless device does not wait the AIFS duration after an idle run backoff (which is every other backoff for a transmit ratio of 1/2), and the AIFS duration is one slot for EDCA, the backoff after an idle run backoff is one less slot (10 slots in the example). Therefore, the first wireless device transmits, on average, every 21 slots (11 slots+10 slots) in the example.

When the first wireless device is performing an idle run backoff, each of the other wireless devices determines the interruptions per transmission to be 3, because the first wireless device does not transmit during its transmit opportunity when performing an idle run backoff. Therefore, the contention window for the other devices may alternate between 20 slots (14+2*3), when the first wireless device does not transmit, and 22 slots (14+2*4), when the first wireless device transmits. Again, if the non-random backoff value equals CW/2, then the other wireless devices alternate between transmitting every 10 slots and every 11 slots. Hence, each of the other wireless devices transmits, on average, twice every 21 slots (10+11).

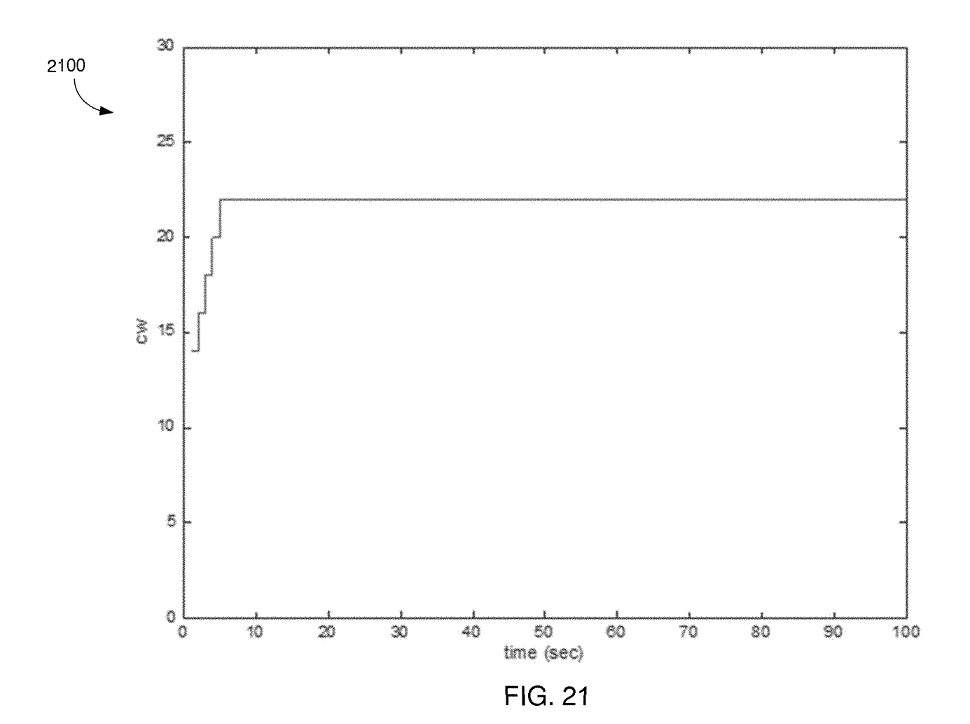

FIG. 21 shows an example graph 2100 illustrating the simulated contention window size for the first wireless device in the above example, wherein the first wireless device is initialized first and the other devices are initialized in one second increments. As illustrated, the contention window increases from 14 slots, to 16 slots, to 18 slots, to 20 slots, and finally to 22 slots. The contention window for the first wireless device stays steady because the other devices transmit during each of their respective transmit opportunities.

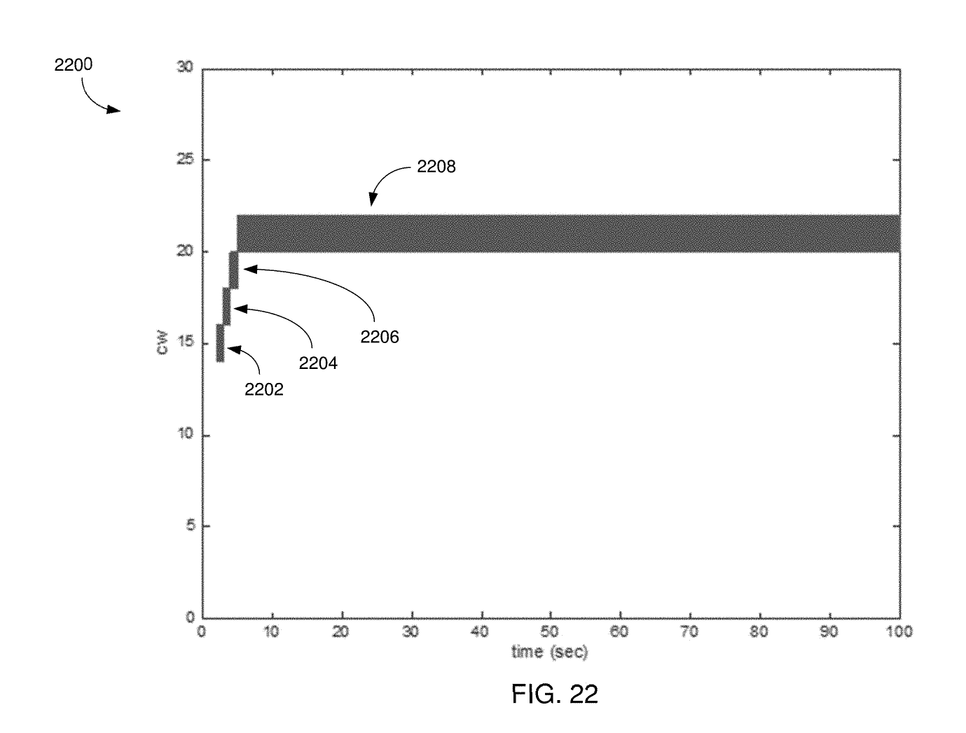

FIG. 22 shows an example graph 2200 illustrating the simulated contention window size for the wireless device initialized after the first wireless device in the above example, wherein the first wireless device transmits every other transmit opportunity (transmit ratio=1/2). As illustrated, when two devices are initialized in 2202 (and the first wireless device transmits every other transmit opportunity), the contention window for the other initialized device alternates between 14 slots (when the first wireless device does not transmit) and 16 slots (when first wireless device transmits). When three devices are initialized in 2204, the contention window varies between 16 and 18 slots. When four devices are initialized in 2206, the contention window varies between 18 and 20 slots. When all devices are initialized in 2208, the contention window varies between 20 and 22 slots.

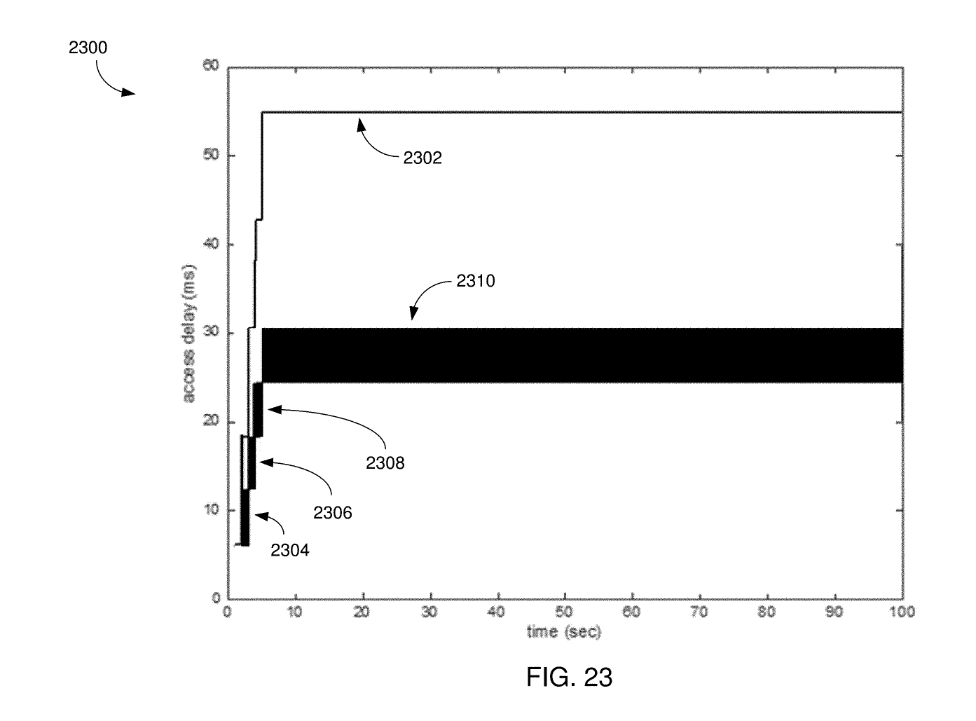

FIG. 23 shows an example graph 2300 illustrating the simulated wireless medium access delay (in ms) for the first wireless device and the next initialized device. 2302 illustrates the access delay for the first wireless device. As other devices are initialized (and the first wireless device foregoes transmitting every other transmit opportunity), the access delay increases from approximately 6 ms, to approximately 18 ms, to approximately 31 ms, to approximately 43 ms, to approximately 54 ms. The access delay (2302) increases about twice as much for the first wireless device than for other wireless devices when another device is initialized because the first wireless device transmits only every other transmit opportunity (while the other devices transmit every transmit opportunity). Access delays for the other wireless device (indicated by 2304 when two initialized devices, 2306 when three initialized devices, 2308 when four initialized devices, and 2310 when all five devices are initialized) vary depending on whether the first wireless device is transmitting (or foregoing transmission, thereby altering the interruptions per transmission observed by the other devices).

In a second example to illustrate using transmit ratios less than 1, there exist 10 wireless devices, wherein the first wireless device has a transmit ratio=3/5 (the wireless device transmits 3 out of every 5 transmit opportunities) and the other devices have a transmit ratio=1 (the other devices transmit every transmit opportunity). The first wireless device determines the interruptions per transmission to be 9 for every backoff since the other devices do not forego any transmit opportunities. Therefore, if the contention window size is determined using EQ. 8, the first wireless device determines its contention window to be 32 slots (14+2*9). If the non-random backoff value equals CW/2, then the first wireless device may wait 16 slots (32/2) after transmission for its next backoff, or may wait 15 slots (32/2−1) after foregoing a transmit opportunity (an idle run backoff) for its next backoff.

For 5 backoffs (which includes 2 idle run backoffs), the first wireless device may transmit 3 times every 78 slots (316 slots+215 slots). Therefore, on average, the first wireless device may transmit every 26 slots.

The other devices determine the interruptions per transmission to vary between 8 (when the first wireless device foregoes a transmit opportunity) and 9 (when the first wireless device transmits during its transmit opportunity). As a result, the contention window for the other devices varies between 30 slots (14+2*8) and 32 slots (14+2*9). If the non-random backoff value is CW/2, then the backoff for the other 9 devices varies between 15 slots (30/2) and 16 slots (32/2). Therefore, 5 backoffs for the other devices (where the first wireless device's transmit ratio=3/5) are together 78 slots (2*15 slots+3*16 slots), which averages to approximately 15.6 slots per transmit opportunity (78 slots/5 backoffs).

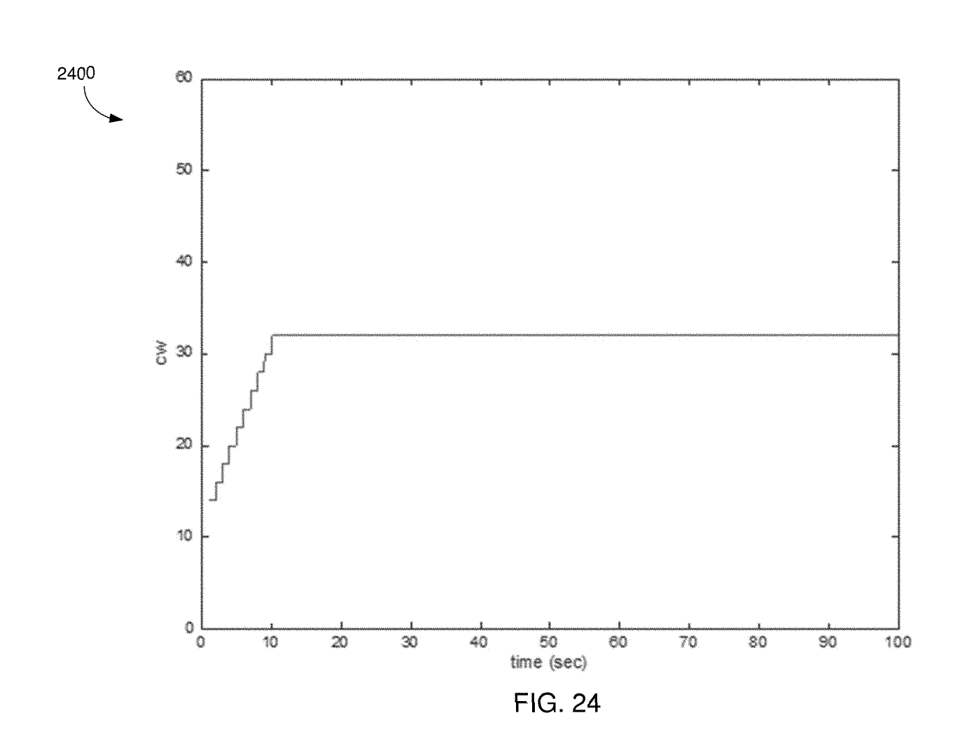

FIG. 24 shows an example graph 2400 illustrating the simulated contention window size for the first wireless device in the above example of 10 wireless devices, wherein the first wireless device is initialized first, the other devices are initialized in one second increments, and the transmit ratio for the first wireless device is 3/5. As illustrated, the contention window for the first wireless device increase from 14 slots to 32 slots by 2 slot increments as each of the other 9 devices are initialized.

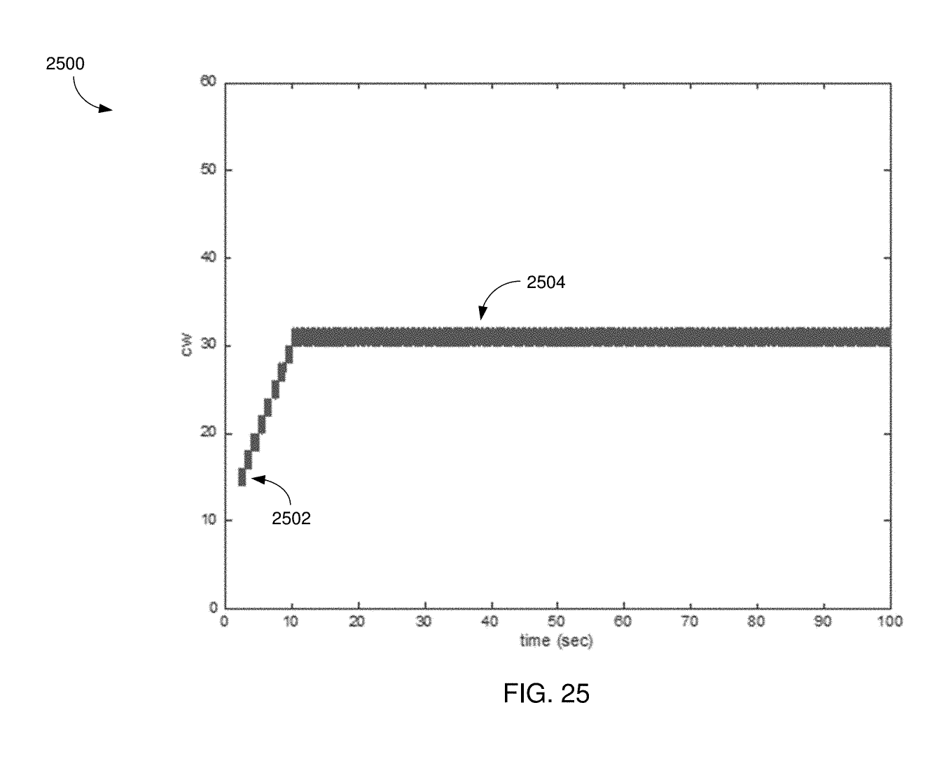

FIG. 25 shows an example graph 2500 illustrating the simulated contention window size for the wireless device initialized after the first wireless device in the above example, wherein the first wireless device's transmit ratio is 3/5. As illustrated, when a device is initialized, the range for the contention window increases by 2 slots. For example, when two devices (the first wireless device and the other device) are initialized in 2502, the contention window for the other device varies between 14 slots (IPT=0) and 16 slots (IPT=1). When all ten devices are initialized in 2504, the contention window for the other device varies between 30 slots (IPT=8) and 32 slots (IPT=9).

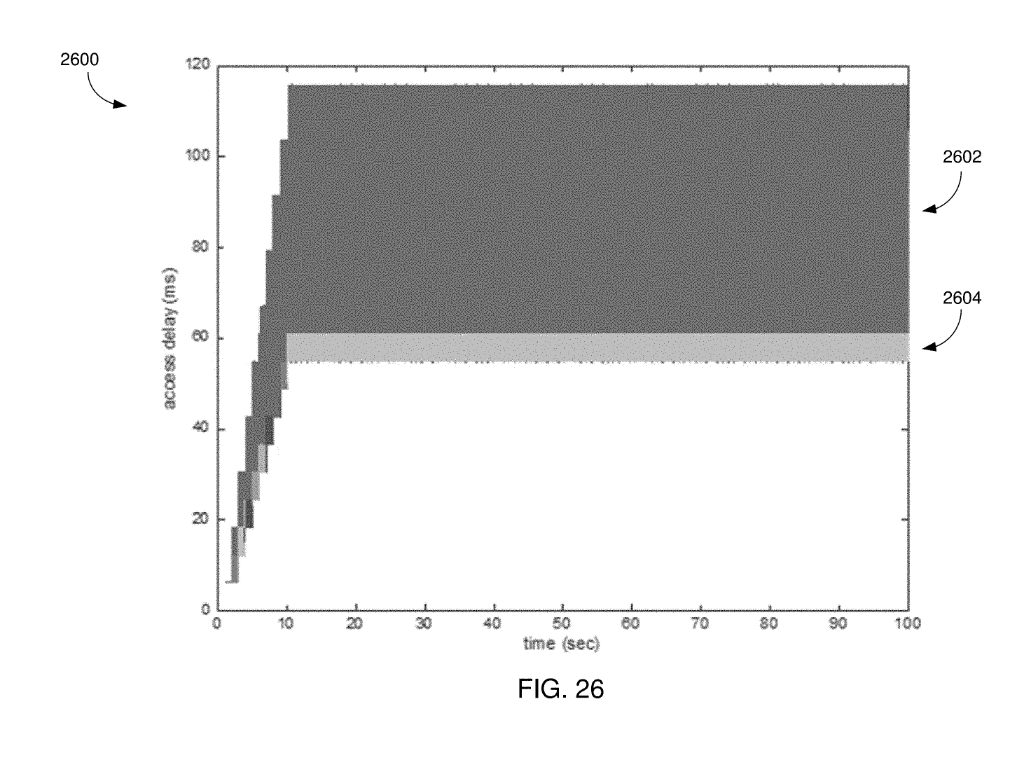

FIG. 26 shows an example graph 2600 illustrating the simulated wireless medium access delay (in ms) for the first wireless device and the next initialized device. 2602 illustrates the access delay (and its variance) for the first wireless device, and 2604 illustrates the access delay (and its variance) for the next initialized device, once all ten devices are initialized. Unlike the previous example where the first wireless device (with a transmit ratio of 1/2) transmitted every 21 slots, the first wireless device (with a transmit ratio of 1/2) in the present example may transmit during two consecutive transmit opportunities. Therefore, the first wireless device sometimes transmits after 16 slots (for two consecutive non-idle run backoffs) and sometimes transmits after 31 slots (for an idle run backoff followed by a non-idle run backoff). 2602 illustrates that the access delay may approximately double for the first wireless device, depending on the type of consecutive backoffs being run by the first wireless device. 2604 illustrates that the access delay for the second initiated device varies in a smaller range, depending on if the wireless device transmits or foregoes transmission during its transmit opportunity.

IPT may indicate the number of other devices contending for the wireless medium. For the example of CW=14+2*IPT and the non-random backoff value is CW/2, the non-random backoff value (NRB) may be written in terms of IPT, as illustrated in EQ. 10 below:

NRB=CW/2=(14+2*IPT)/2=7+IPT (EQ. 10)

Since IPT may indicate the number of other device contending for the wireless medium, EQ. 10 implies for this example that, for any number of devices contending for the wireless medium (indicated by IPT), 7 available slots exist during each non-random backoff. Thus, for this example, a wireless device may typically observe 7 available slots (when no transmission occurs in the subsequent slot) during each non-random backoff. While the relationship between CW and IPT may differ, and the non-random backoff value may include a different number of available slots, the number of available slots per non-random backoff may be fixed. EQ. 10 corresponds to EQ. 8, EQ. 8a, and EQ. 8b when the damping factor is equal to 0 (instead of 0.6). In this example, the Target CW=14 for no interruptions (EQ. 8), and the NRB=14/2=7. The Target CW increases by uniform increments of 2 for each additional interruption, and the NRB increases by uniform increments of 1 for each additional interruption.

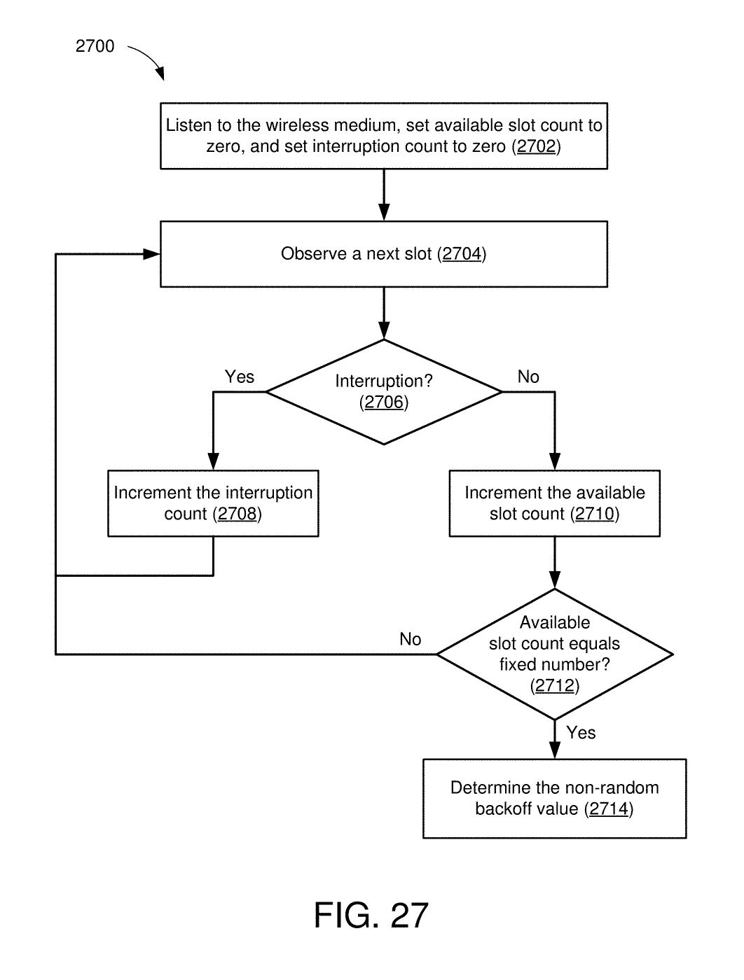

FIG. 27 shows an illustrative flowchart depicting an example operation for a wireless device beginning to listen to a wireless medium to determine the length of the non-random backoff (such as determining the non-random backoff value). Beginning at 2702, the wireless device listens to the wireless medium. The wireless device may be recently initialized or otherwise does not know or is to update its non-random backoff value. While listening to the wireless medium, the wireless device may observe available slots until a fixed number of available slots is observed. Hence, the wireless device may set an available slot count to zero in 2702. The wireless device may also observe and count interruptions that occur while observing a fixed number of available slots. Thus, the wireless device may also set an interruption count to zero in 2702.

In 2704, the wireless device observes a next slot. In 2706, if an interruption is observed for the slot, the wireless device increases the interruption count by one in 2708 (and the process reverts to 2704 to observe the next slot). If no interruption is observed, the prior slot is presumed to be an available slot, and the available slot count is increased by one in 2710. The wireless device then determines if the available slot count equals the fixed number of available slots to be observed in 2712. If the available slot count does not yet equal the fixed number, then the process reverts to 2704, and the wireless device observes the next slot. If the available slot count equals the fixed number, then the wireless device determines the non-random backoff value (2714). In some example embodiments, the wireless device may determine the non-random backoff value to be the number of interruptions counted (indicating the number of other devices contending for the wireless medium) plus the fixed number of available slots.

For example, if the number of available slots per non-random backoff is 7 (as in EQ. 10 above), the wireless device may listen to the wireless medium during an initial phase and observe a number of interruptions until 7 available slots are observed. The wireless device may then use the number of interruptions observed/counted during this time to determine the non-random backoff value to be used by the wireless device after the initial phase, where the non-random backoff value (NRB) equals the number of interruptions counted (NI) plus 7 (NRB=NI+7).

The wireless device may determine a slot to be an available slot, but the slot may typically be used by another device (with, e.g., the other device currently idle and performing an idle run backoff). In some example embodiments, the wireless device listens to the wireless medium for a plurality of iterations of the fixed number of available slots. Therefore, if an interruption begins to occur for one of the slots in a later iteration, the wireless device may determine that the previously presumed available slot is not an available slot. As a result, the wireless device may redetermine the number of interruptions that occur when observing the fixed number of available slots (after removing the slot previously determined as an available slot but for which an interruption was observed).

Once the non-random backoff value is determined (such as from the number of interruptions counted plus the fixed number of available slots), the wireless device may perform a non-random backoff using the non-random backoff value. The wireless device may thus operate (including, e.g., adjusting the non-random backoff) as otherwise described.

As previously described, a wireless device may detect collisions (such as to determine contention window size, if the backoff is to be adjusted, and so on). Also as previously described, one way a collision may be detected is by not receiving an acknowledgement from a receiving device for a transmission (thus assuming a collision occurred). However, if a receiving device is sufficiently close to a transmitting device, the receiving device may receive the transmission, irrespective of interference, and send an acknowledgement. Thus, there is a region near the transmitting device where the transmit power overcomes the signal energy from an interferer, which may affect determining collisions.

In some aspects of the present disclosure, a receiving device may infer a collision when receiving a wireless signal (even though the receiving device is able to receive the wireless signal). Additionally, the receiving device may indicate the inferred collision to the transmitting device. Alternatively, the transmitting device may infer a collision from information received from the receiving device regarding noise levels or characteristics.

In some example embodiments, a receiving device may use changes in noise levels to infer a collision. For example, a receiving device may determine a difference in noise levels between when a wireless signal is received and before the wireless signal is received (inferring if another device is attempting to transmit during the same slot as the transmitting device). For example, a receiving device may determine a signal to noise ratio (SNR) or signal to interference plus noise ratio (SINR) for a packet received from the transmitting device. Then, the receiving device may compare an expected SNR (or SINR) to the determined SNR (or SINR) for the packet.

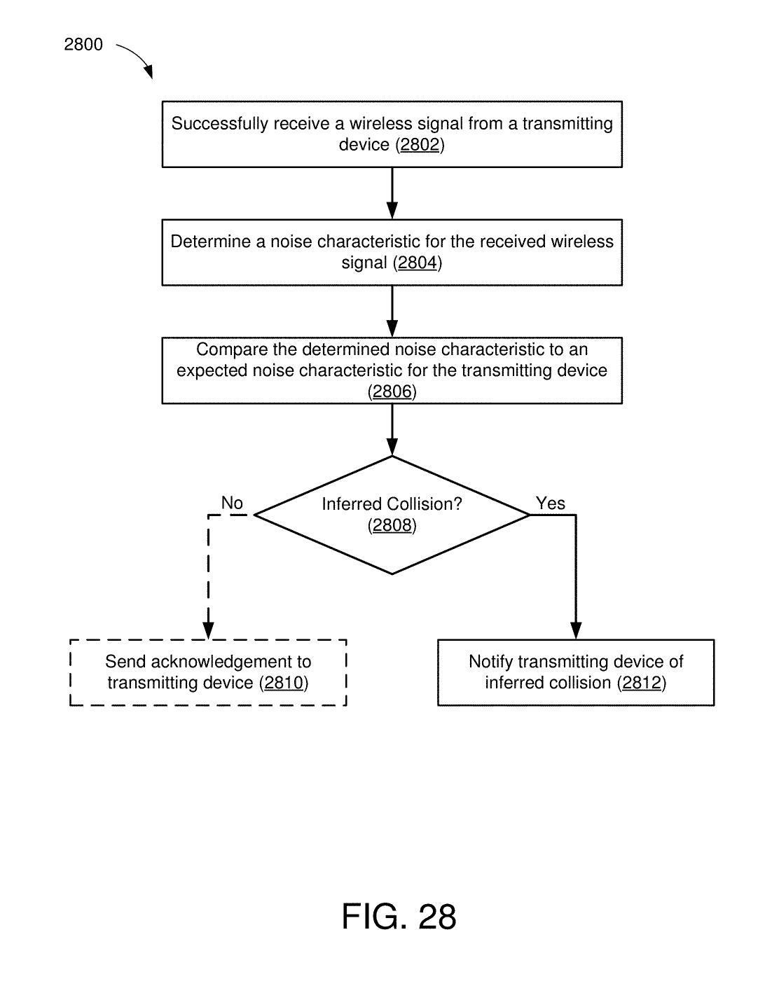

FIG. 28 shows an illustrative flowchart depicting an example operation 2800 for a receiving device to infer a collision for a received wireless signal. Beginning at 2802, the receiving device successfully receives a wireless signal (such as a packet) from a transmitting device. Proceeding to 2804, the receiving device determines a noise characteristic for the received wireless signal. For example, the receiving device may determine the SNR or the SINR for the wireless signal. However, other characteristics may be determined and used. The receiving device then compares the determined noise characteristic (such as a determined SNR, determined SINR, and so on) to an expected noise characteristic (such as an expected SNR, expected SINR, and so on) for the transmitting device (2806).

In some example embodiments, the expected noise characteristic for a transmitting device may be related to the distance between the transmitting device and the receiving device. For example, as the distance increases between two devices, the signal strength of a packet received by the receiving device decreases, and the SNR decreases. Therefore, the receiving device may determine an expected noise characteristic for the transmitting device based on the distance between the two devices. As a result, the receiving device may use a different expected noise characteristic (such as a different SNR) for each transmitting device. Determining an expected noise characteristic is described in more detail later.

Referring back to FIG. 28, from the comparison between the determined noise characteristic and the expected noise characteristic (2806), the receiving device determines if a collision is inferred (2808). In some example embodiments, the receiving device infers a collision if the determined SNR is less than the expected SNR. In other example embodiments, the receiving device includes a tolerance (or threshold) so that the receiving devices compares if the determined SNR is less than the expected SNR by more than the tolerance (or threshold). The tolerance may be static, transmitting device specific, or also depend on the distance between the two devices. The tolerance may additionally or alternatively depend on if and the number of previous collisions associated with the transmitting device.

Referring again to FIG. 28, if a collision is not inferred in 2808, the receiving device operates as it typically does when receiving a wireless signal (such as, e.g., sending an acknowledgement to the transmitting device that the wireless signal was received (2810)). Thus, the transmitting device does not observe a collision for the transmission. If a collision is inferred in 2808, the receiving device may notify the transmitting device of the inferred collision (2812).

The receiving device may notify the transmitting device of the inferred collision in a variety of ways. In some example embodiments, if the receiving device provides an acknowledgement (ACK) to the transmitting device, the transmitting device may determine from not receiving an acknowledgement that a collision occurred. Thus, the receiving device may prevent sending an acknowledgement so that the transmitting determines that a collision occurred even though the receiving device received the wireless signal. For example, when an initial packet is sent at a robust rate (such as for a Request to Send (RTS) or a Clear to Send (CTS)), the receiving device may receive the packet. However, the receiving device may prevent a response being sent to the transmitting device if the noise level during reception of the RTS or CTS is elevated compared to the noise level just before reception of the RTS or CTS.

In other example embodiments, the receiving device may notify the transmitting device through a field in a response to the transmitting device (such as in a non-null data packet for an acknowledgement to the transmitting device). Such notification may be close to real time. In other example embodiments, the receiving device may send a management or control message to the transmitting device to indicate an inferred collision (or a change in noise levels or characteristics).

Referring back to determining an expected noise characteristic, the expected noise characteristic may be related to the distance between the receiving device and the transmitting device. In some example embodiments, beacons may be used to determine a distance between devices. For example, a beacon may include a timestamp. Thus, a receiving device may use the timestamp and the time of reception to determine how much time elapsed between transmission and reception. Using the difference in time, the receiving device can then calculate a distance between the devices. In other example embodiments, the devices may use sounding or other types of signals. For sounding, a device may determine a round trip time (RTT) between the device and the other device to calculate a distance between the devices. Alternatively, other methods for determining distance may be used by the device (such as use of sensors, programmed distance for static location devices, and so on).

While the above examples illustrate the receiving device inferring collisions, in other example embodiments, the transmitting device may infer the collision. For example, the receiving device may determine and compare noise levels or characteristics. The receiving device can then notify the transmitting device if (and optionally how much) the noise level is increased or the noise characteristic varies before and during reception. The transmitting device can then use the information to determine if a collision is inferred.

If a collision is inferred during distributed round robin, then the transmitting device may, e.g., adjust the backoff by applying randomness (as previously described). Inferring a collision may also be performed by devices that use exponential backoff (in which case, an inferred collision may cause a doubling of the contention window).

In the foregoing specification, the aspects of the present disclosure have been described with reference to specific exemplary embodiments thereof. It will, however, be evident that various modifications and changes may be made thereto without departing from the broader scope of the disclosure as set forth in the appended claims. For example, the operations described above, such as the operations in FIGS. 9, 12, 13A, 13B, 16, 19-20, and 27-28 may be performed by any wireless device. Example devices include, but are not limited to, an EDCA device (such as illustrated in FIG. 2 and described above) and an LBE device (such as illustrated in FIG. 3 and described above), which may perform the example operations. In some example embodiments, the SW modules 244 and 245 of the EDCA device and the SW modules 344 and 345 of the LBE device may include instructions that, when executed by each device's respective processor, cause the wireless device to perform all or part of the example operations. Additionally, the example embodiments are not limited to being performed by EDCA and LBE devices, as such devices are only illustrative examples. Therefore, the specification and drawings are, accordingly, to be regarded in an illustrative sense rather than a restrictive sense. For example, method steps depicted in the flow charts of FIGS. 11-12, 13A, 13B, 16, 19-20, and 27-28 may be performed in other suitable orders and/or one or more method steps may be omitted.

What is claimed is:

1. A wireless device for sharing access to a wireless medium with other wireless devices, comprising:
one or more processors; and
a memory configured to store instructions that, when executed by the one or more processors, cause the wireless device to:
perform a first backoff using a first backoff value;
transmit on the wireless medium after performing the first backoff; and
use a non-random backoff value to perform a subsequent backoff when the transmission is successful.

2. The wireless device of claim 1, wherein execution of the instructions further causes the wireless device to:
determine a random backoff value when transmission is not successful;
perform a second backoff using the random backoff value; and
transmit on the wireless medium after performing the second backoff.

3. The wireless device of claim 2, wherein execution of the instructions further causes the wireless device to:
infer that a collision occurs in determining that the transmission is not successful, wherein the random backoff value is determined in response to inferring that the collision occurs.

4. The wireless device of claim 1, wherein execution of the instructions further causes the wireless device to:
determine a contention window size for backoff, wherein the non-random backoff value is related to the contention window size.

5. The wireless device of claim 4, wherein the non-random backoff value equals half of the contention window size.

6. The wireless device of claim 4, wherein execution of the instructions further causes the wireless device to:
adjust the contention window size based on the amount of activity on the wireless medium.

7. The wireless device of claim 6, wherein the amount of activity on the wireless medium is the number of interruptions during the backoff.

8. The wireless device of claim 1, wherein execution of the instructions further causes the wireless device to:
observe a fixed number of available slots while listening to the wireless medium;
determine a number of observed interruptions that occur while observing the fixed number of available slots; and
determine the non-random backoff value based at least in part on the number of observed interruptions.

9. A method for a wireless device to share access to a wireless medium with other wireless devices, comprising:
performing a first backoff using a first backoff value;
transmitting on the wireless medium after performing the first backoff; and
using a non-random backoff value to perform a subsequent backoff when transmission is successful.

10. The method of claim 9, further comprising:
determining a random backoff value when the transmission is not successful;
performing a second backoff using the random backoff value; and
transmitting on the wireless medium after performing the second backoff.

11. The method of claim 10, further comprising:
inferring that a collision occurs in determining that the transmission is not successful, wherein the random backoff value is determined in response to inferring that the collision occurs.

12. The method of claim 9, further comprising:
determining a contention window size for backoff, wherein the non-random backoff value is related to the contention window size.

13. The method of claim 12, wherein the non-random backoff value equals half of the contention window size.

14. The method of claim 12, further comprising:
adjusting the contention window size based on the amount of activity on the wireless medium.

15. The method of claim 14, wherein the amount of activity on the wireless medium is the number of interruptions during a backoff.

16. The method of claim 9, further comprising:
observing a fixed number of available slots while listening to the wireless medium;
determining a number of observed interruptions that occur while observing the fixed number of available slots; and
determining the non-random backoff value based at least in part on the number of observed interruptions.

17. A wireless device for sharing access to a wireless medium with other wireless devices, comprising:
means for performing a first backoff using a first backoff value;
means for transmitting on the wireless medium after performing the first backoff; and
means for using a non-random backoff value to perform a subsequent backoff when the transmission is successful.

18. The wireless device of claim 17, further comprising:
means for determining a random backoff value when transmission is not successful;
means for performing a second backoff using the random backoff value; and
means for transmitting on the wireless medium after performing the second backoff.

19. The wireless device of claim 18, further comprising:
means for inferring that a collision occurs in determining that the transmission is not successful, wherein the random backoff value is determined in response to inferring that the collision occurs.

20. The wireless device of claim 17, further comprising:
means for determining a contention window size for backoff, wherein the non-random backoff value is related to the contention window size.

21. The wireless device of claim 20, wherein the non-random backoff value equals half of the contention window size.

22. The wireless device of claim 21, further comprising:
means for adjusting the contention window size based on a number of interruptions during a backoff.

23. The wireless device of claim 17, further comprising:
means for observing a fixed number of available slots while listening to the wireless medium;
means for determining a number of observed interruptions that occur while observing the fixed number of available slots; and
means for determining the non-random backoff value based at least in part on the number of observed interruptions.

24. A non-transitory computer-readable storage medium storing one or more programs containing instructions that, when executed by one or more processors of a wireless device, cause the wireless device to perform operations comprising:
performing a first backoff using a first backoff value;
transmitting on the wireless medium after performing the first backoff; and
using a non-random backoff value to perform a subsequent backoff when the transmission is successful.

25. The non-transitory computer-readable storage medium of claim 24, wherein execution of the instructions further cause the wireless device to perform operations comprising:
determining a random backoff value when the transmission is not successful;
performing a second backoff using the random backoff value; and
transmitting on the wireless medium after performing the second backoff.

26. The non-transitory computer-readable storage medium of claim 25, wherein execution of the instructions further cause the wireless device to perform operations comprising:
inferring that a collision occurs in determining that the transmission is not successful, wherein the random backoff value is determined in response to inferring that the collision occurs.

27. The non-transitory computer-readable storage medium of claim 24, wherein the instructions further cause the wireless device to perform operations comprising:
determining a contention window size for backoff, wherein the non-random backoff value is related to the contention window size.

28. The non-transitory computer-readable storage medium of claim 27, wherein the non-random backoff value equals half of the contention window size.

29. The non-transitory computer-readable storage medium of claim 27, wherein the instructions further cause the wireless device to perform operations comprising:
adjusting the contention window size based on a number of interruptions during a backoff.

30. The non-transitory computer-readable storage medium of claim 24, wherein the instructions further cause the wireless device to perform operations comprising:
observing a fixed number of available slots while listening to the wireless medium;
determining a number of observed interruptions that occur while observing the fixed number of available slots; and
determining the non-random backoff value based at least in part on the number of observed interruptions.
